(19) United States
(12) Patent Application Publication
(10) Pub. No.: US 2019/0128834 A1
(43) Pub. Date: May 2, 2019

(54) SOX INDEX ACQUISITION APPARATUS FOR INTERNAL COMBUSTION ENGINE

(71) Applicant: TOYOTA JIDOSHA KABUSHIKI KAISHA, Toyota-shi (JP)

(72) Inventors: Kazuhisa MATSUDA, Atsugi-shi (JP); Kazuhiro WAKAO, Susono-shi (JP); Keiichiro AOKI, Sunto-gun (JP); Masahito NAKAYAMA, Fujinomiya-shi (JP)

(73) Assignee: TOYOTA JIDOSHA KABUSHIKI KAISHA, Toyota-shi (JP)

(21) Appl. No.: 16/161,172

(22) Filed: Oct. 16, 2018

(30) Foreign Application Priority Data
Oct. 26, 2017 (JP) 2017-206811

(51) Int. Cl. G01N 27/406; G01N 27/407; G01N 27/416; F01N 11/00

(52) U.S. Cl. CPC G01N 27/4065; G01N 27/407; F01N 2900/1402; F01N 11/00; G01N 27/4163

(57) ABSTRACT

An SOx index acquisition apparatus for an internal combustion engine includes a sensor cell, a voltage source. The sensor cell includes a solid electrolyte and a pair of electrodes disposed so as to sandwich the solid electrolyte. The voltage source applies a voltage to the sensor cell. The apparatus acquires a resistance value of the sensor cell as a sensor resistance, decreases an applied voltage, which is a voltage that is applied to the sensor cell, from a predetermined voltage, acquires a current that passes through the sensor cell while the applied voltage is being decreased from the predetermined voltage, as an SOx sensor current, acquires a base SOx concentration, which correlates with an SOx concentration in exhaust gas, based on parameters including the SOx sensor current, and acquires the SOx concentration as an SOx index by correcting the base SOx concentration based on the sensor resistance.

### CROSS-REFERENCE TO RELATED APPLICATIONS

This application claims priority to Japanese Patent Application No. 2017-206811 filed on Oct. 26, 2017, which is incorporated herein by reference in its entirety.

### BACKGROUND

### 1. Technical Field

The disclosure relates to an SOx index acquisition apparatus for an internal combustion engine.

### 2. Description of Related Art

There is known an SOx index acquisition apparatus (see, for example, Japanese Unexamined Patent Application Publication No. 2015-017931 (JP 2015-017931 A)). The SOx index acquisition apparatus acquires the concentration of sulfur oxides (hereinafter, referred to as SOx) in exhaust gas with a current that is output from a limiting current sensor. The exhaust gas is emitted from an internal combustion engine.

### SUMMARY

The sensor of the above-described SOx index acquisition apparatus includes a solid electrolyte and electrodes respectively disposed on both wall surfaces of the solid electrolyte. The SOx index acquisition apparatus applies a predetermined voltage between the electrodes of the sensor, and then acquires an SOx concentration based on a current that passes as a result of an electrochemical reaction that occurs on the electrodes when a voltage that is applied between the electrodes is decreased.

A noble metal, such as platinum, is employed as the electrodes. This noble metal causes the electrochemical reaction to occur. Therefore, if this noble metal degrades due to the heat of exhaust gas, or the like, an electrochemical reaction that occurs on the electrodes is difficult to proceed. In this situation, even when exhaust gas having the same SOx concentration comes to the electrodes, a variation in current that passes as a result of an electrochemical reaction reduces. This makes it difficult to acquire an accurate SOx concentration.

The disclosure is made to address the above-described inconvenience. That is, the disclosure provides an SOx index acquisition apparatus for an internal combustion engine, which is able to acquire an accurate SOx concentration even when electrodes of a sensor degrade.

An aspect of the disclosure provides an SOx index acquisition apparatus for an internal combustion engine. The SOx index acquisition apparatus includes a sensor cell, a voltage source, and an electronic control unit. The sensor cell includes a solid electrolyte and a pair of electrodes disposed so as to sandwich the solid electrolyte. The voltage source is configured to apply a voltage to the sensor cell. The electronic control unit is configured to (i) acquire a resistance of the sensor cell as a sensor resistance, (ii) decrease an applied voltage from a predetermined voltage, the applied voltage being a voltage that is applied to the sensor cell, (iii) acquire a current that passes through the sensor cell while the applied voltage is being decreased from the predetermined voltage, as an SOx sensor current, (iv) acquire a base SOx concentration based on parameters including the SOx sensor current, the base SOx concentration correlating with an SOx concentration in exhaust gas that is emitted from the internal combustion engine, and (v) acquire one of (a) the SOx concentration as an SOx index by correcting the base SOx concentration based on the sensor resistance, or (b) the SOx concentration as an SOx index based on a corrected parameter by acquiring the corrected parameter by correcting at least one of the parameters based on the sensor resistance.

The inventors of the present application have found out that the value of a current that passes through the sensor cell while the applied voltage is being decreased from the predetermined voltage, that is, the SOx sensor current, correlates with an SOx concentration in exhaust gas coming to the sensor cell. On the other hand, the electrodes of the sensor cell and the solid electrolyte can degrade due to the heat of exhaust gas, or the like. As these electrodes and solid electrolyte degrade, current is difficult to pass through the sensor cell. Therefore, even when an SOx concentration in exhaust gas coming to the sensor cell is the same, as the degree of degradation of the sensor cell increases, a variation in SOx sensor current reduces. As a result, when an SOx concentration is acquired based on an SOx sensor current without considering the degree of degradation of the sensor cell, it is not possible to acquire an accurate SOx concentration.

In this regard, the inventors of the present application have found out that a resistance value of the sensor cell, that is, the sensor resistance, correlates with the degree of degradation of the sensor cell, and the sensor resistance is larger when the degree of degradation of the sensor cell is high than when the degree of degradation of the sensor cell is low.

The SOx index acquisition apparatus acquires a base SOx concentration based on an SOx sensor current and acquires an SOx concentration by correcting the base SOx concentration based on a sensor resistance. Alternatively, the SOx index acquisition apparatus acquires a corrected sensor current value by correcting an SOx sensor current based on a sensor resistance and acquires an SOx concentration based on the corrected sensor current value. Therefore, with the SOx index acquisition apparatus, it is possible to acquire an accurate SOx concentration as an SOx index.

Another aspect of the disclosure provides an SOx index acquisition apparatus for an internal combustion engine. The SOx index acquisition apparatus includes a sensor cell, a voltage source, and an electronic control unit. The sensor cell includes a solid electrolyte and a pair of electrodes disposed so as to sandwich the solid electrolyte. The voltage source is configured to apply a voltage to the sensor cell. The electronic control unit is configured to (i) acquire a resistance of the sensor cell as a sensor resistance, (ii) decrease an applied voltage from a predetermined voltage, the applied voltage being a voltage that is applied to the sensor cell, (iii) acquire a current that passes through the sensor cell while the applied voltage is being decreased from the predetermined voltage, as an SOx sensor current, (iv) acquire a corrected upper limit concentration by correcting a base upper limit concentration based on the sensor resistance, the base upper limit concentration being set based on an allowable upper limit value of an SOx concentration in exhaust gas that is emitted from the internal combustion engine, (v) and acquire one of (c) a determination result that the SOx concentration in the exhaust gas is higher than the allowable upper limit value, as an SOx index, when the SOx concentration is higher than the corrected upper limit concentration, by acquiring the SOx concentration based on parameters including the SOx sensor current and by determining whether the SOx concentration is higher than the corrected upper limit concentration, or (d) a determination result that the SOx concentration in the exhaust gas is higher than the allowable upper limit value based on a comparison result of the SOx sensor current with the corrected determination current, as an SOx index by acquiring a corrected determination current by correcting a base determination current based on the sensor resistance, the base determination current being related to the SOx sensor current corresponding to the base upper limit concentration, and by comparing the SOx sensor current with the corrected determination current.

As described above, as the degree of degradation of the sensor cell increases, a variation in SOx sensor current reduces even when an SOx concentration in exhaust gas coming to the sensor cell is the same. Therefore, when an SOx concentration is acquired based on an SOx sensor current, it is not possible to acquire an accurate SOx concentration. As a result, even when it is determined whether an SOx concentration is higher than a base upper limit concentration with the base upper limit concentration and the SOx concentration acquired based on the SOx sensor current without considering the degree of degradation of the sensor cell or even when an SOx sensor current is compared with a base determination current, it is not possible to acquire an accurate determination result.

The SOx index acquisition apparatus determines whether an SOx concentration is higher than a base upper limit concentration with a corrected upper limit concentration acquired by correcting the base upper limit concentration based on a sensor resistance or with a corrected determination current acquired by correcting a base determination current based on a sensor resistance. As a result, with the SOx index acquisition apparatus, it is possible to acquire an accurate determination result as to whether an SOx concentration is higher than a base upper limit concentration.

In the SOx index acquisition apparatus, the sensor resistance may be an electrode interface resistance that is a resistance at an interface between the solid electrolyte and one of the electrodes or may be a resistance of the solid electrolyte.

The electronic control unit of the SOx index acquisition apparatus may be configured to acquire a peak value of a current that passes through the sensor cell while the applied voltage is being decreased from the predetermined voltage, as the SOx sensor current.

A peak value of a current (hereinafter, referred to as peak current) that passes through the sensor cell while the applied voltage is being decreased from the predetermined voltage is a value at the time when a current that passes through the sensor cell while the applied voltage is being decreased from the predetermined voltage has varied the most. Therefore, a peak current accurately corresponds to an SOx concentration in exhaust gas. As a result, with the SOx index acquisition apparatus, it is possible to acquire a more accurate SOx concentration by acquiring a peak current as an SOx sensor current.

In the SOx index acquisition apparatus, the electronic control unit may be configured to (i) apply a voltage lower than the predetermined voltage before the predetermined voltage is applied to the sensor cell, (ii) increase the applied voltage that is applied to the sensor cell, to the predetermined voltage, (iii) decrease the applied voltage from the predetermined voltage, after increasing the applied voltage to the predetermined voltage, and (iv) acquire a current that passes through the sensor cell while the applied voltage is being decreased from the predetermined voltage, as the SOx sensor current.

Through the research of the inventors of the present application, it was have found out that, when an applied voltage is increased to a predetermined voltage and then decreased from the predetermined voltage, a current that passes through the sensor cell while the applied voltage is being decreased from the predetermined voltage more accurately corresponds to an SOx concentration in exhaust gas. Therefore, with the SOx index acquisition apparatus, by increasing the applied voltage to the predetermined voltage and then acquiring a current that passes through the sensor cell while the applied voltage is being decreased from the predetermined voltage, as an SOx sensor current, it is possible to acquire a more accurate SOx concentration.

In the SOx index acquisition apparatus, the electronic control unit may be configured to (i) decrease the applied voltage from the predetermined voltage, and then apply a voltage lower than the predetermined voltage to the sensor cell as an oxygen concentration acquisition voltage, (ii) acquire a current that passes through the sensor cell while the oxygen concentration acquisition voltage is being applied to the sensor cell, as an oxygen sensor current, and (iii) acquire an oxygen concentration in the exhaust gas based on the oxygen sensor current.

In the SOx index acquisition apparatus, the electronic control unit may be configured to (i) apply a voltage lower than the predetermined voltage to the sensor cell as an oxygen concentration acquisition voltage before the predetermined voltage is applied to the sensor cell, (ii) acquire a current that passes through the sensor cell while the oxygen concentration acquisition voltage is being applied to the sensor cell, as an oxygen sensor current, and (iii) acquire an oxygen concentration in the exhaust gas based on the oxygen sensor current.

With the thus configured SOx index acquisition apparatus, in addition to an SOx concentration or a determination result as to whether an SOx concentration is higher than a base upper limit concentration, it is possible to acquire an oxygen concentration in exhaust gas.

Other objects, other characteristics, and associated advantages of the disclosure would easily be understood from a description about embodiments of the disclosure with reference to the accompanying drawings.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram that shows an internal combustion engine including an SOx index acquisition apparatus according to a first embodiment of the disclosure (hereinafter, referred to as first embodiment apparatus);

FIG. 2 is a diagram that shows the internal structure of a sensor of the first embodiment apparatus;

FIG. 3 is a graph that shows the relation among a voltage (sensor voltage) that is applied to a sensor cell of the sensor of the first embodiment apparatus, a current (sensor current) that passes through the sensor, and an oxygen concentration in exhaust gas;

FIG. 4A is a graph that shows the relation between a voltage (sensor voltage) that is applied to the sensor cell of the first embodiment apparatus and a current (sensor current) that passes through the sensor cell when exhaust gas not containing SOx has been coming to the sensor;

FIG. 4B is a graph that shows the relation between a voltage (sensor voltage) that is applied to the sensor cell of the first embodiment apparatus and a current (sensor current) that passes through the sensor cell when exhaust gas containing SOx has been coming to the sensor;

FIG. 5 is a graph that shows the relation between a peak value and an SOx concentration;

FIG. 6 is a timing chart that shows a variation in voltage (sensor voltage) that is applied to the sensor cell of the first embodiment apparatus and a variation in current (sensor current) that passes through the sensor cell;

FIG. 7 is a view that shows a mode of increase and decrease in voltage (sensor voltage) that is applied to the sensor cell of the first embodiment apparatus;

FIG. 8A is a diagram that shows an equivalent circuit of an electric circuit including the sensor cell;

FIG. 8B is a view that shows a Nyquist diagram;

FIG. 9 is a flowchart that shows a routine that is executed by a CPU of a sensor ECU of the first embodiment apparatus;

FIG. 10 is a flowchart that shows a routine that is executed by the CPU of the sensor ECU of the first embodiment apparatus;

FIG. 11 is a flowchart that shows a routine that is executed by a CPU of a sensor ECU of a first alternative apparatus that is an alternative embodiment of the SOx index acquisition apparatus according to the first embodiment (first embodiment apparatus);

FIG. 12 is a flowchart that shows a routine that is executed by a CPU of a sensor ECU of a second embodiment apparatus that is an SOx index acquisition apparatus according to a second embodiment of the disclosure;

FIG. 13 is a diagram that shows an internal combustion engine including a third embodiment apparatus that is an SOx index acquisition apparatus according to a third embodiment of the disclosure;

FIG. 14 is a diagram that shows the internal structure of a sensor of the third embodiment apparatus;

FIG. 15 is a graph that shows the relation between an NOx concentration and a current that passes through a sensor cell (sensor current);

FIG. 16 is a flowchart that shows a routine that is executed by a CPU of a sensor ECU of the third embodiment apparatus; and

FIG. 17 is a timing chart that shows a mode of a variation in voltage (sensor voltage) that is applied to the sensor cell of each of the embodiment apparatuses and alternative apparatuses according to the embodiments.

### DETAILED DESCRIPTION OF EMBODIMENTS

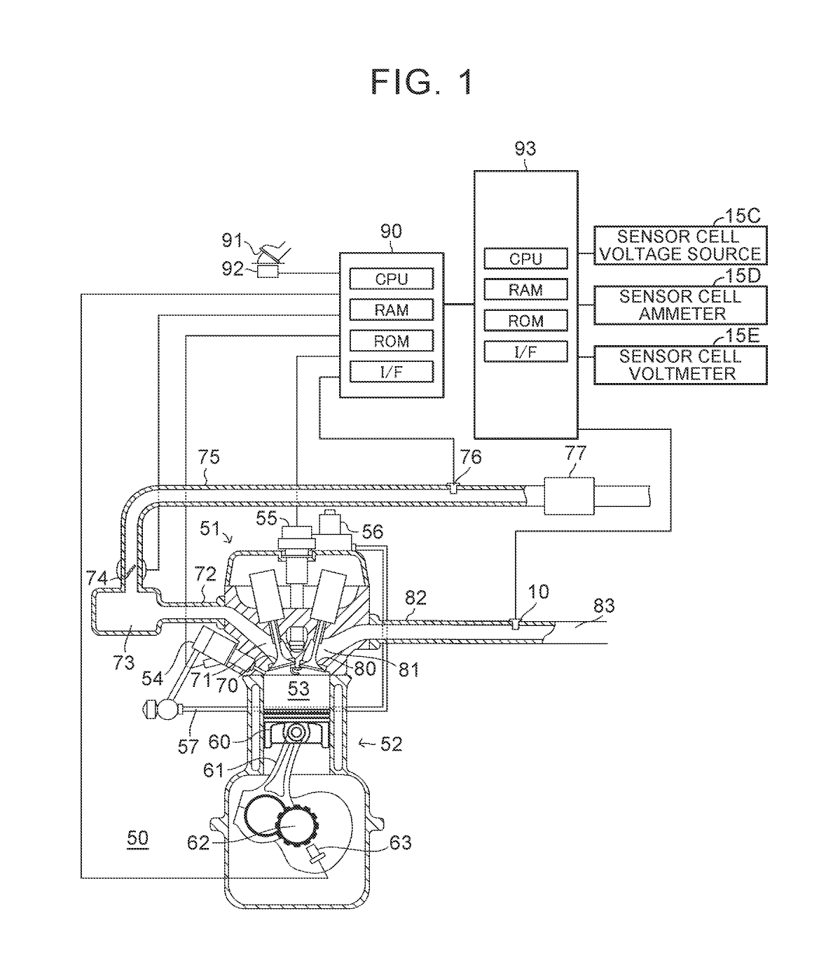

Hereinafter, SOx index acquisition apparatuses for an internal combustion engine according to embodiments of the disclosure will be described with reference to the accompanying drawings. An SOx index acquisition apparatus according to a first embodiment of the disclosure (hereinafter, referred to as first embodiment apparatus) is applied to an internal combustion engine shown in FIG. 1.

The internal combustion engine shown in FIG. 1 is a spark ignition internal combustion engine (so-called gasoline engine). However, the disclosure is also applicable to a compression ignition internal combustion engine (so-called diesel engine). The internal combustion engine shown in FIG. 1 is operated at a stoichiometric air-fuel ratio in most of an engine operating range.

FIG. 1 shows the body 50 of the internal combustion engine, a cylinder head 51, a cylinder block 52, a combustion chamber 53, a fuel injection valve 54, an ignition plug 55, a fuel pump 56, a fuel feeding pipe 57, a piston 60, a connecting rod 61, a crankshaft 62, a crank angle sensor 63, an intake valve 70, an intake port 71, an intake manifold 72, a surge tank 73, a throttle valve 74, an intake pipe 75, an air flow meter 76, an air filter 77, an exhaust valve 80, an exhaust port 81, an exhaust manifold 82, an exhaust pipe 83, an electronic control unit 90, an accelerator pedal 91, and an accelerator pedal position sensor 92.

The fuel injection valve 54, the ignition plug 55, the throttle valve 74, the crank angle sensor 63, the air flow meter 76, the accelerator pedal position sensor 92, and limiting current sensors 10, 20 are electrically connected to the electronic control unit 90.

The electronic control unit 90 is an electronic control circuit having a microcomputer as a main component. The microcomputer includes a CPU, a ROM, a RAM, an interface, and the like. The CPU implements various functions (described later) by executing instructions (routines) stored in a memory (ROM).

The electronic control unit 90 transmits signals for actuating the fuel injection valve 54, the ignition plug 55, and the throttle valve 74 to these fuel injection valve 54, ignition plug 55, and throttle valve 74. The electronic control unit 90 receives signals from the crank angle sensor 63, the air flow meter 76, and the accelerator pedal position sensor 92. A signal corresponding to the rotation speed of the crankshaft 62 is output from the crank angle sensor 63. The electronic control unit 90 calculates an engine rotation speed based on the signal received from the crank angle sensor 63. A signal corresponding to the flow rate of air that passes through the air flow meter 76 (by extension, the flow rate of air that is taken into the combustion chamber 53) is output from the air flow meter 76. The electronic control unit 90 calculates an intake air amount based on the signal received from the air flow meter 76. A signal corresponding to a depression amount of the accelerator pedal 91 is output from the accelerator pedal position sensor 92. The electronic control unit 90 calculates an engine load based on the signal received from the accelerator pedal position sensor 92.

The first embodiment apparatus includes the limiting current sensor 10, a sensor cell voltage source 15C, an sensor cell ammeter 15D, a sensor cell voltmeter 15E, and a sensor ECU 93. The limiting current sensor 10 (hereinafter, simply referred to as sensor 10) is a single cell-type limiting current sensor, and is disposed in the exhaust pipe 83.

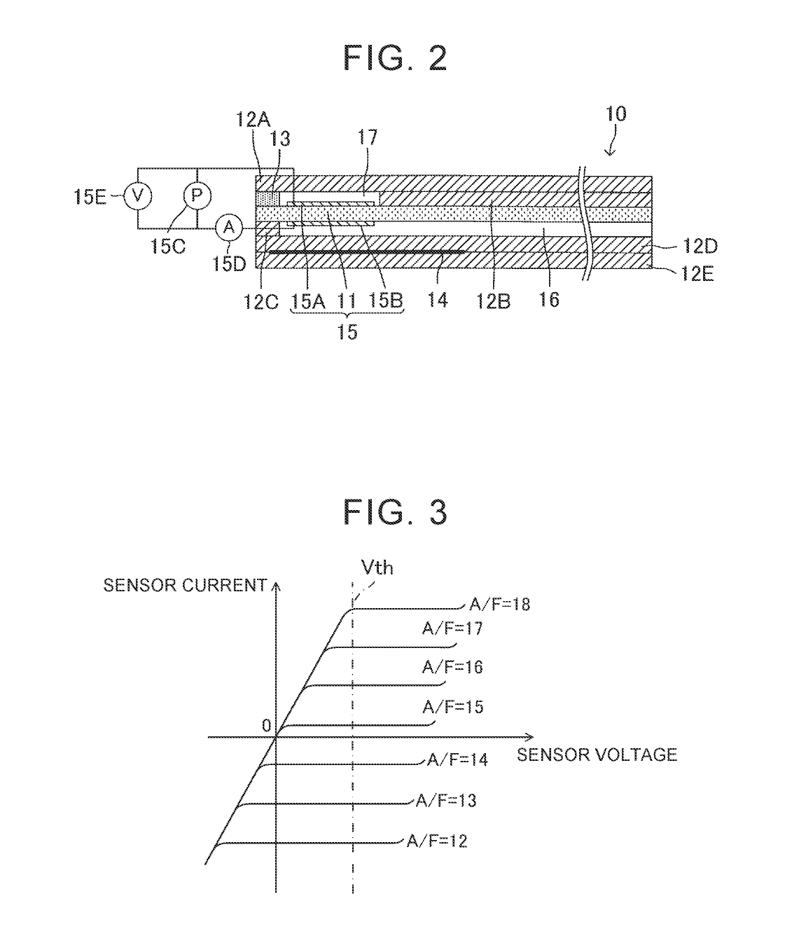

As shown in FIG. 2, the sensor 10 includes a first alumina layer 12A, a second alumina layer 12B, a third alumina layer 12C, a fourth alumina layer 12D, a fifth alumina layer 12E, a diffusion-controlling layer 13, a heater 14, a sensor cell 15, an atmosphere introducing passage 16, and an internal space 17. The sensor cell 15 includes a solid electrolyte layer 11, a first sensor electrode 15A, and a second sensor electrode 15B.

The solid electrolyte layer 11 is a layer made of zirconia, and the like. The solid electrolyte layer 11 has an oxygen ion conductivity. Each of the alumina layers 12A, 12B, 12C, 12D, 12E is a layer made of alumina. The diffusion-controlling layer 13 is a porous layer. The diffusion-controlling layer 13 allows exhaust gas to pass therethrough. In the sensor 10, the layers are laminated in order of the fifth alumina layer 12E, the fourth alumina layer 12D, the third alumina layer 12C, the solid electrolyte layer 11, the diffusion-controlling layer 13 and second alumina layer 12B, and the first alumina layer 12A from the bottom in FIG. 2. The heater 14 is disposed between the fourth alumina layer 12D and the fifth alumina layer 12E.

The atmosphere introducing passage 16 is a space defined by the solid electrolyte layer 11, the third alumina layer 12C, and the fourth alumina layer 12D. Part of the atmosphere introducing passage 16 is open to the atmosphere. The internal space 17 is a space defined by the first alumina layer 12A, the solid electrolyte layer 11, the diffusion-controlling layer 13, and the second alumina layer 12B. Part of the internal space 17 communicates with the outside of the sensor 10 via the diffusion-controlling layer 13.

Each of the first sensor electrode 15A and the second sensor electrode 15B is an electrode made of a material having high reducing properties (for example, an element of the platinum group, such as platinum and rhodium, or an alloy of an element of the platinum group). The first sensor electrode 15A is disposed on a first-side wall surface of the solid electrolyte layer 11 (that is, a wall surface of the solid electrolyte layer 11, which defines the internal space 17). The second sensor electrode 15B is disposed on a second-side wall surface of the solid electrolyte layer 11 (that is, a wall surface of the solid electrolyte layer 11, which defines the atmosphere introducing passage 16). These electrodes 15A, 15B and solid electrolyte layer 11 constitute the sensor cell 15.

The sensor 10 is configured to be able to apply a voltage from the sensor cell voltage source 15C to the sensor cell 15 (specifically, between the first sensor electrode 15A and the second sensor electrode 15B). The sensor cell voltage source 15C is configured to be able to selectively apply a direct-current voltage or alternating-current voltage to the sensor cell 15. When the sensor cell voltage source 15C applies a direct-current voltage to the sensor cell 15, the first sensor electrode 15A is a cathode electrode, and the second sensor electrode 15B is an anode electrode.

The sensor ECU 93 is an electronic control unit. The sensor ECU 93 is an electronic control circuit having a microcomputer as a main component. The microcomputer includes a CPU, a ROM, a RAM, an interface, and the like. The CPU implements various functions (described later) by executing instructions (routines) stored in a memory (ROM).

The heater 14, the sensor cell voltage source 15C, the ammeter 15D, and the voltmeter 15E are connected to the sensor ECU 93.

The sensor ECU 93 controls the operation of the heater 14 such that the temperature of the sensor cell 15 is kept at a predetermined constant temperature (that is, sensor activation temperature).

The sensor ECU 93 also controls the voltage of the sensor cell voltage source 15C such that a voltage that is set as will be described later is applied from the sensor cell voltage source 15C to the sensor cell 15.

The sensor cell ammeter 15D detects a current Iss passing through a circuit including the sensor cell 15 (hereinafter, referred to as sensor current Iss), and outputs a signal representing the detected sensor current Iss to the sensor ECU 93. The sensor ECU 93 acquires the sensor current Iss based on the signal.

The sensor cell voltmeter 15E detects a voltage Vss that is applied to the sensor cell 15 (hereinafter, referred to as sensor voltage Vss), and outputs a signal representing the detected sensor voltage Vss to the sensor ECU 93. The sensor ECU 93 acquires the sensor voltage Vss based on the signal.

Next, the outline of the operation of the first embodiment apparatus will be described. Initially, acquisition of an SOx concentration will be described. While a voltage is being applied to the sensor cell 15, when sulfur oxides (hereinafter, referred to as SOx) in the internal space 17 come into contact with the first sensor electrode 15A, the SOx are reduced and decomposed on the first sensor electrode 15A. After that, oxygen in the SOx is ionized into oxygen ions, and the oxygen ions migrate toward the second sensor electrode 15B through the solid electrolyte layer 11. At this time, a current proportional to the amount of oxygen ions migrated through the solid electrolyte layer 11 passes between the first sensor electrode 15A and the second sensor electrode 15B. As the oxygen ions reach the second sensor electrode 15B, the oxygen ions become oxygen on the second sensor electrode 15B, and the oxygen is released to the atmosphere introducing passage 16.

The sensor voltage Vss, the sensor current Iss, and the air-fuel ratio A/F of exhaust gas have a relation with one another as shown in FIG. 3. The sensor voltage Vss is a direct-current voltage that is applied to the sensor cell 15 by the sensor cell voltage source 15C. The sensor current Iss is a current that passes between the first sensor electrode 15A and the second sensor electrode 15B when a voltage is applied to the sensor cell 15. The air-fuel ratio A/F of exhaust gas corresponds to the air-fuel ratio of air-fuel mixture that is formed inside the combustion chamber 53, and is hereinafter referred to as exhaust gas air-fuel ratio A/F.

In FIG. 3, the line indicated by A/F=12 represents a variation in sensor current Iss with a variation in sensor voltage Vss in the case where the exhaust gas air-fuel ratio A/F is 12. Similarly, the line indicated by A/F=13 represents a variation in sensor current Iss with a variation in sensor voltage Vss in the case where the exhaust gas air-fuel ratio A/F is 13. The line indicated by A/F=14 represents a variation in sensor current Iss with a variation in sensor voltage Vss in the case where the exhaust gas air-fuel ratio A/F is 14. The line indicated by A/F=15 represents a variation in sensor current Iss with a variation in sensor voltage Vss in the case where the exhaust gas air-fuel ratio A/F is 15. The line indicated by A/F=16 represents a variation in sensor current Iss with a variation in sensor voltage Vss in the case where the exhaust gas air-fuel ratio A/F is 16. The line indicated by A/F=17 represents a variation in sensor current Iss with a variation in sensor voltage Vss in the case where the exhaust gas air-fuel ratio A/F is 17. The line indicated by A/F=18 represents a variation in sensor current Iss with a variation in sensor voltage Vss in the case where the exhaust gas air-fuel ratio A/F is 18.

For example, when the exhaust gas air-fuel ratio A/F is 18, within the range in which the sensor voltage Vss is lower than a predetermined value Vth, the absolute value of the sensor current Iss reduces as the sensor voltage Vss increases in the case where the sensor current Iss is a negative value; whereas the absolute value of the sensor current Iss increases as the sensor voltage Vss increases in the case where the sensor current Iss is a positive value. On the other hand, within a constant range in which the sensor voltage Vss is higher than or equal to the predetermined value Vth, the sensor current Iss is a constant value irrespective of the sensor voltage Vss.

Such a relation between the sensor voltage Vss and the sensor current Iss similarly holds also in the case where the exhaust gas air-fuel ratio A/F is 12, 13, 14, 15, 16, or 17.

With regard to the sensor 10 having such output characteristics of the sensor current Iss, the inventors of the present application have found out that a sensor current Iss corresponding to an SOx concentration in exhaust gas is obtained by decreasing a sensor voltage Vss below the predetermined voltage. Next, this will be described. In the following description, an oxygen concentration in exhaust gas is constant at 1%.

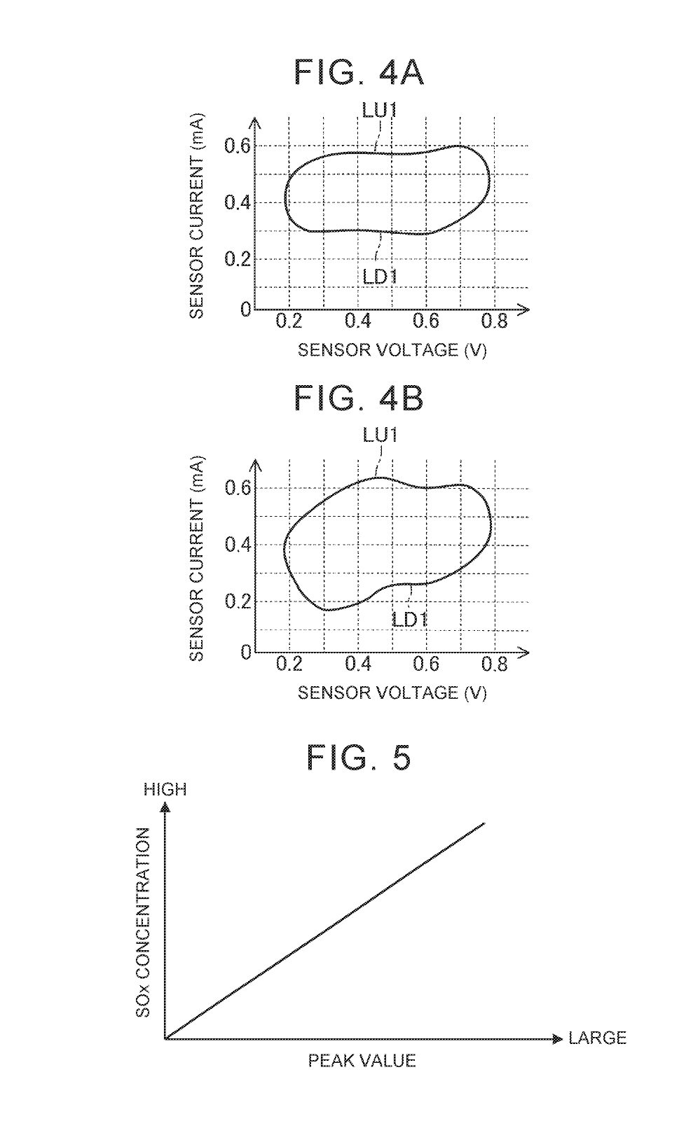

FIG. 4A shows a variation in sensor current Iss when the sensor voltage Vss is increased from 0.2 V (strictly, in the example shown in FIG. 4A, a voltage slightly lower than 0.2 V) to 0.8 V (strictly, in the example shown in FIG. 4A, a voltage slightly lower than 0.8 V) and then the sensor voltage Vss is decreased from 0.8 V to the original 0.2 V in the case where exhaust gas not containing SOx has been coming to the first sensor electrode 15A.

As the sensor voltage Vss begins to increase from 0.2 V, the sensor current Iss begins to increase from approximately 0.35 mA, as indicated by the line LU1 in FIG. 4A. Subsequently, after the sensor voltage Vss becomes approximately 0.4 V, the sensor current Iss slightly decreases. Subsequently, after the sensor voltage V becomes approximately 0.5 V, the sensor current Iss slightly increases. Subsequently, after the sensor voltage Vss becomes approximately 0.7 V, the sensor current Iss decreases. As the sensor voltage Vss reaches 0.8 V, the sensor current Iss is approximately 0.5 mA.

After that, as the sensor voltage Vss begins to decrease from 0.8 V, the sensor current Iss begins to decrease from approximately 0.5 mA, as indicated by the line LD1 in FIG. 4A. Subsequently, after the sensor voltage Vss becomes approximately 0.6 V, the sensor current Iss is constant at approximately 0.3 mA. Subsequently, after the sensor voltage Vss becomes approximately 0.22 V, the sensor current Iss increases. As the sensor voltage Vss reaches 0.2 V, the sensor current Iss is approximately 0.35 mA.

On the other hand, FIG. 4B shows a variation in sensor current Iss when the sensor voltage Vss is increased from 0.2 V (strictly, in the example shown in FIG. 4B, a voltage slightly lower than 0.2 V) to 0.8 V (strictly, in the example shown in FIG. 4B, a voltage slightly lower than 0.8 V) and then the sensor voltage Vss is decreased from 0.8 V to the original 0.2 V in the case where exhaust gas containing SOx has been coming to the first sensor electrode 15A.

As the sensor voltage Vss begins to increase from 0.2 V, the sensor current Iss begins to increase from approximately 0.35 mA, as indicated by the line LU1 in FIG. 4B. Subsequently, after the sensor voltage Vss becomes approximately 0.45 V, the sensor current Iss slightly decreases. Subsequently, after the sensor voltage V becomes approximately 0.6 V, the sensor current Iss slightly increases. Subsequently, after the sensor voltage Vss becomes approximately 0.7 V, the sensor current Iss decreases. As the sensor voltage Vss reaches 0.8 V, the sensor current Iss is approximately 0.5 mA.

After that, as the sensor voltage Vss begins to decrease from 0.8 V, the sensor current Iss begins to decrease from approximately 0.5 mA, as indicated by the line LD1 in FIG. 4B. Subsequently, after the sensor voltage Vss becomes approximately 0.3 V, the sensor current Iss increases. That is, when the sensor voltage Vss becomes approximately 0.3 V, the sensor current Iss becomes a minimum value. As the sensor voltage Vss reaches 0.2 V, the sensor current Iss is approximately 0.35 mA.

In this way, when exhaust gas containing SOx has been coming to the first sensor electrode 15A, as the sensor voltage Vss is decreased from 0.8 V to 0.2 V, the sensor current Iss exhibits a variation with a minimum value (that is, peak current Ipeak). As described above, in the present embodiment, at the time when the sensor voltage Vss has reached approximately 0.3 V, the sensor current Iss is the peak current Ipeak.

The inventors of the present application further have found out the following facts. Before the sensor voltage Vss is increased to 0.8 V in order to acquire an SOx concentration Csox, 0.4 V that is the sensor voltage Vss at which it is possible to cause the sensor current Iss commensurate with an oxygen concentration to be output is applied to the sensor cell 15, the sensor current Iss at this time is acquired as a reference current Iref, and then a difference between the reference current Iref and the peak current Ipeak of the sensor current Iss when the sensor voltage Vss is decreased from 0.8 V to 0.2 V is acquired as a peak value dIpeak. In this case, the peak value dIpeak and the SOx concentration Csox have such a relation that the SOx concentration in exhaust gas increases as the peak value dIpeak increases, as shown in FIG. 5.

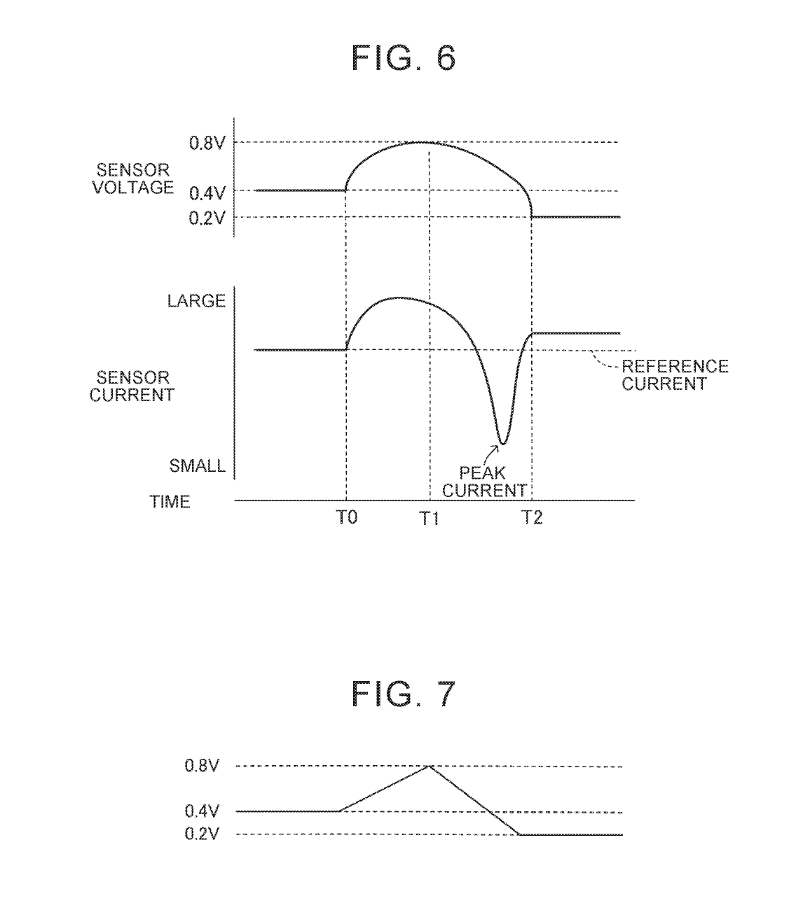

As shown in FIG. 6, the first embodiment apparatus regularly keeps the sensor voltage Vss at 0.4 V (see the duration before time T0). The first embodiment apparatus increases the sensor voltage Vss from 0.4 V to 0.8 V such that the rate of increase in sensor voltage Vss gradually decreases (see the duration from time T0 to time T1), and, after that, decreases the sensor voltage Vss from 0.8 V to 0.2 V such that the rate of decrease in sensor voltage Vss gradually increases (see the duration from time T1 to time T2).

The first embodiment apparatus acquires a base SOx concentration Csox_base by applying a peak value dIpeak (=|Iref−Iss|) to a look-up table Map1Csox_base(dIpeak). The peak value dIpeak is acquired while the sensor voltage Vss is being decreased from 0.8 V to 0.2 V. The first embodiment apparatus acquires an SOx concentration Csox by correcting the base SOx concentration Csox_base with a correction coefficient Kc (described later). The SOx concentration Csox is an index related to an SOx concentration (hereinafter, referred to as SOx index). According to the table Map1Csox_base(dIpeak), as the peak value dIpeak increases, a higher base SOx concentration Csox_base is acquired.

The first embodiment apparatus decreases the sensor voltage Vss from 0.8 V to 0.2 V, then increases the sensor voltage Vss from 0.2 V, and keeps the sensor voltage Vss constant at 0.4 V.

When the first embodiment apparatus increases the sensor voltage Vss in order to acquire an SOx concentration Csox, the first embodiment apparatus may also be configured to once decrease the sensor voltage Vss from 0.4 V to 0.2 V and then increase the sensor voltage Vss from 0.2 V to 0.8 V.

Incidentally, if the rate (sweep rate) of decrease in sensor voltage Vss for acquiring an SOx concentration Csox is too high, no peak current Ipeak can possibly be output or no peak current Ipeak sufficiently corresponding to an SOx concentration Csox can possibly be output even when the sensor voltage Vss is decreased. It is desirable to select the rate of decrease in sensor voltage Vss at which a peak current Ipeak sufficiently corresponding to an SOx concentration Csox is output when the sensor voltage Vss is decreased.

The first embodiment apparatus varies the sensor voltage Vss such that, where a variation in sensor voltage Vss that is increased from 0.4 V to 0.8 V and then decreased from 0.8 V to 0.2 V is represented as a frequency, this frequency is lower than or equal to 100 Hz. In other words, a period of time from when an increase in sensor voltage Vss begins until a decrease in sensor voltage Vss ends is desirably longer than or equal to 0.01 seconds.

The first embodiment apparatus may be configured to increase the sensor voltage Vss from 0.4 V to 0.8 V such that the rate of increase in sensor voltage Vss is kept constant and then decrease the sensor voltage Vss from 0.8 V to 0.2 V such that the rate of decrease in sensor voltage Vss is kept constant, as shown in FIG. 7.

A peak current Ipeak is an output current that is most different from the sensor current Iss in the case where the SOx concentration is zero, within the sensor current Iss during a decrease in sensor voltage Vss. Therefore, a peak current Ipeak is regarded as a sensor current Iss that accurately corresponds to an SOx concentration. As a result, it is possible to accurately acquire an SOx concentration with a peak current Ipeak as a sensor current Iss for acquiring an SOx concentration.

The first embodiment apparatus applies a voltage of 0.4 V to the sensor cell 15 before the first embodiment apparatus begins to decrease the sensor voltage Vss. This voltage is lower than 0.8 V that is the sensor voltage Vss at the time when the sensor voltage Vss begins to decrease. As a result, in comparison with the case where a voltage of 0.8 V is applied to the sensor cell 15 before the sensor voltage Vss begins to decrease, it is possible to decrease electric power that is consumed to acquire an SOx concentration.

The reason why a sensor current Iss corresponding to an SOx concentration is output from the sensor 10 when the sensor voltage Vss is decreased is presumably because a reaction concerned with SOx is occurring on the sensor cell 15. This reaction related to SOx is significantly influenced by the temperature of the sensor cell 15. Therefore, in consideration of an exceedingly low concentration of SOx in exhaust gas, it is desirable to keep the temperature of the sensor cell 15 constant in order to accurately acquire an SOx concentration.

The first embodiment apparatus controls the operation of the heater 14 such that the temperature of the sensor cell 15 is kept at a predetermined constant temperature. Therefore, it is possible to accurately acquire an SOx concentration.

The sensor voltage Vss at the beginning of increase in sensor voltage Vss (that is, the sensor voltage Vss that is regularly applied to the sensor cell 15) is not limited to 0.4 V. The sensor voltage Vss at the beginning of increase in sensor voltage Vss may be any voltage that causes a variation in sensor current Iss. The sensor current Iss has a peak current Ipeak when the sensor voltage Vss is increased and then the sensor voltage Vss is decreased. The sensor voltage Vss at the beginning of increase in sensor voltage Vss just needs to be, for example, lower than or equal to 0.6 V, and may be particularly 0.2 V.

The sensor voltage Vss at the end of increase in sensor voltage Vss is not limited to 0.8 V. The sensor voltage Vss at the end of increase in sensor voltage Vss just needs to be a voltage that causes a variation in sensor current Iss that has a peak current Ipeak when the sensor voltage Vss is increased and then the sensor voltage Vss is decreased. Alternatively, the sensor voltage Vss at the end of increase in sensor voltage Vss just needs to be a voltage higher than or equal to a maximum voltage of a stable output voltage range (that is, a range in which the sensor current Iss is approximately constant irrespective of the sensor voltage Vss when the SOx concentration is zero; for example, a range of 0.2 V to 0.8 V). The sensor voltage Vss at the end of increase in sensor voltage Vss just needs to be, for example, higher than or equal to 0.8 V.

The sensor voltage Vss at the end of decrease in sensor voltage Vss is not limited to 0.2 V. The sensor voltage Vss at the end of decrease in sensor voltage Vss just needs to be a voltage lower than or equal to the sensor voltage Vss at which the peak current Ipeak is output from the sensor cell 15.

The first embodiment apparatus uses the peak current Ipeak in order to acquire an SOx concentration Csox. Instead, the first embodiment apparatus may also be configured to use an output current within a range in which the sensor current Iss rapidly decreases or a range in which the sensor current Iss rapidly increases, while the sensor voltage Vss is decreased from 0.8 V to 0.2 V.

Instead of acquiring an SOx concentration Csox with the peak current Ipeak and the reference current Iref, the first embodiment apparatus may also be configured to acquire an SOx concentration Csox by multiplying a conversion coefficient Kconvert by the peak current Ipeak (Csox=Ipeak·Kconvert). In this case, the conversion coefficient Kconvert is set as follows. When the peak current Ipeak is a negative value, an SOx concentration Csox to be acquired increases as the absolute value of the peak current Ipeak increases. When the peak current Ipeak is a positive value, an SOx concentration Csox to be acquired increases as the absolute value of the peak current Ipeak decreases. The conversion coefficient Kconvert is a coefficient for converting a peak current Ipeak to an SOx concentration Csox in accordance with the relation shown in FIG. 5.

Next, correction of an SOx concentration will be described. Incidentally, the material that constitutes the first sensor electrode 15A can possibly be sintered under the influence of the heat of exhaust gas, or the like, and degrade. If the first sensor electrode 15A degrades, a reaction speed of SOx on the first sensor electrode 15A decreases while the sensor voltage Vss is increased and then decreased in order to acquire an SOx concentration Csox. As a result, a base SOx concentration Csox_base acquired by applying a peak value dIpeak that is acquired at this time to the look-up table Map1Csox_base(dIpeak) is lower than an actual SOx concentration in exhaust gas.

In this regard, the inventors of the present application have found out that an electrical resistance at an interface between the first sensor electrode 15A and the solid electrolyte layer 11 (hereinafter, referred to as electrode interface resistance Rkai) increases as the degree of degradation of the first sensor electrode 15A increases.

The first embodiment apparatus acquires an electrode interface resistance Rkai, and acquires a correction coefficient Kc for correcting the base SOx concentration Csox_base based on the electrode interface resistance Rkai. The base SOx concentration Csox_base is acquired by applying the peak value dIpeak to the look-up table Map1Csox_base(dIpeak). The first embodiment apparatus acquires an SOx concentration Csox by correcting the base SOx concentration Csox_base with the correction coefficient Kc.

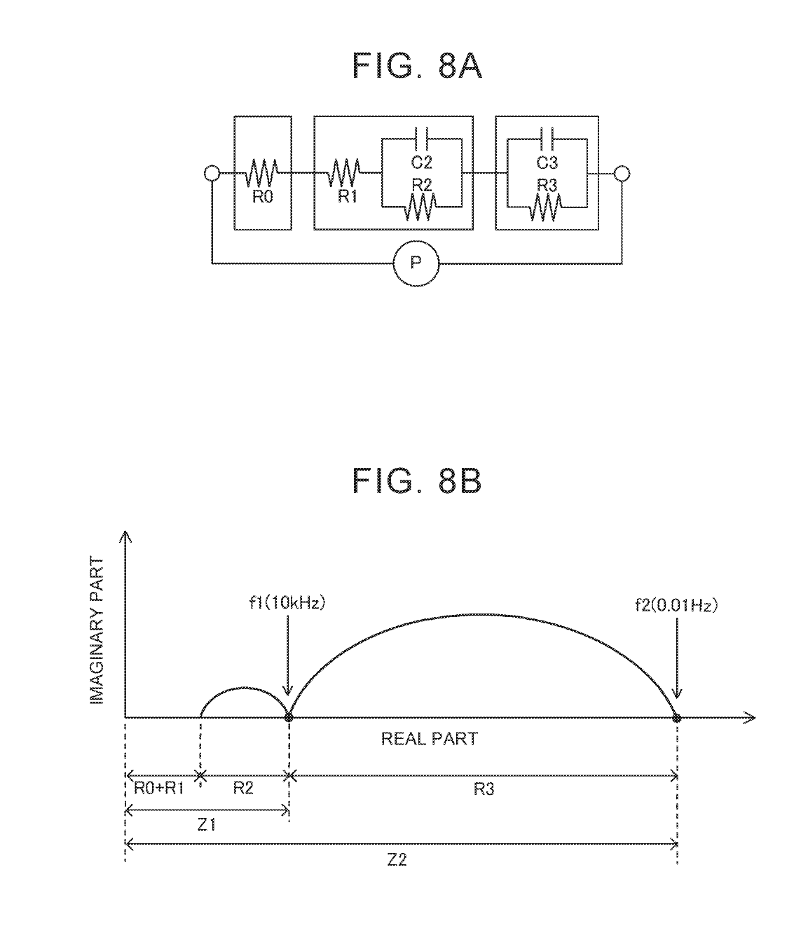

More specifically, an electric circuit including the sensor cell 15 (hereinafter, referred to as sensor cell circuit) is expressed as an equivalent circuit shown in FIG. 8A. In the equivalent circuit shown in FIG. 8A, a resistance R0 is the resistance of a lead portion of the sensor cell circuit, a resistance R1 is the intraparticle resistance of the solid electrolyte layer 11 (bulk resistance), a resistance R2 is the grain boundary resistance of the solid electrolyte layer 11, a capacitive component C2 is the capacitive component of grain boundaries of the solid electrolyte layer 11, a resistance R3 is the electrode interface resistance, and a capacitive component C3 is the capacitive component of the interface between the first sensor electrode 15A and the solid electrolyte layer 11.

There is known that a Nyquist diagram shown in FIG. 8B is obtained when an impedance Z is acquired by applying a voltage V that varies to form a sine wave with 0 V as its center to the equivalent circuit shown in FIG. 8A such that a variation frequency f gradually decreases and then the real part and imaginary part of the acquired impedance Z are plotted such that the abscissa axis represents the real part and the ordinate axis represents the imaginary part.

According to the Nyquist diagram, the imaginary part of the impedance Z acquired when the variation frequency f is a first frequency f1 (10 kHz in this example) (hereinafter, referred to as first impedance Z1) is zero or a local minimum close to zero. The imaginary part of the impedance Z acquired when the variation frequency f is a second frequency f2 (0.01 Hz in this example) (hereinafter, referred to as second impedance Z2) is zero or a local minimum close to zero.

The real part of the first impedance Z1 is a resistance obtained by adding up the resistance R0 of the lead portion, the intraparticle resistance R1 of the solid electrolyte layer 11, and the grain boundary resistance R2 of the solid electrolyte layer 11. On the other hand, the real part of the second impedance Z2 is a resistance obtained by adding up the resistance R0 of the lead portion, the intraparticle resistance R1 of the solid electrolyte layer 11, the grain boundary resistance R2 of the solid electrolyte layer 11, and the electrode interface resistance R3.

Therefore, it is possible to acquire the electrode interface resistance Rkai by subtracting the first impedance Z1 from the second impedance Z2.

The first embodiment apparatus executes first voltage variation control. In the first voltage variation control, the sensor voltage Vss is varied so as to form a sine wave with 0 V as its center, and the variation frequency f of the sensor voltage Vss is varied so as to gradually decrease from a frequency f1_high higher by a predetermined value than a predetermined first frequency f1 to a frequency f1_low lower by a predetermined value than the first frequency f1.

The first embodiment apparatus acquires impedances Z based on sensor voltages Vss and sensor currents Iss, acquired during the first voltage variation control. The first embodiment apparatus acquires the real part of the impedance Z of which the imaginary part is minimum (zero or nearly zero) from among the acquired impedances Z as the first impedance Z1.

The first embodiment apparatus also executes second voltage variation control. In the second voltage variation control, the sensor voltage Vss is varied so as to form a sine wave with 0 V as its center, and the variation frequency f of the sensor voltage Vss is varied so as to gradually decrease from a frequency f2_high higher by a predetermined value than a predetermined second frequency f2 lower than the first frequency f1 to a frequency f2_low lower by a predetermined value than the second frequency f2. The frequency f2_high is a frequency lower than the frequency f1_low.

The first embodiment apparatus acquires impedances Z based on sensor voltages Vss and sensor currents Iss, acquired during the second voltage variation control. The first embodiment apparatus acquires the real part of the impedance Z of which the imaginary part is minimum (zero or nearly zero) from among the acquired impedances Z as the second impedance Z2.

The first embodiment apparatus acquires an electrode interface resistance Rkai by subtracting the first impedance Z1 from the second impedance Z2 (Rkai=Z2−Z1). The first embodiment apparatus acquires a correction coefficient Kc by applying the acquired electrode interface resistance Rkai to a look-up table MapKc(Rkai).

As the degree of degradation of the first sensor electrode 15A increases, the electrode interface resistance Rkai increases, with the result that the passage sensor current Iss for the same SOx concentration increases while the sensor voltage Vss is decreased from 0.8 V to 0.2 V. For this reason, the peak value dIpeak decreases. Therefore, the table MapKc(Rkai) is prepared such that a larger correction coefficient Kc is acquired as the electrode interface resistance Rkai increases. The correction coefficient Kc is a value larger than or equal to one.

The first embodiment apparatus acquires an SOx concentration Csox as an SOx index by correcting a base SOx concentration Csox_base by multiplying a correction coefficient Kc by the base SOx concentration Csox_base (Csox=Csox_base·Kc).

The first embodiment apparatus acquires an SOx concentration Csox by correcting a base SOx concentration Csox_base with an electrode interface resistance Rkai that varies in accordance with the degree of degradation of the first sensor electrode 15A. Therefore, the first embodiment apparatus is able to acquire an accurate SOx concentration Csox as an SOx index even when the first sensor electrode 15A degrades.

The first embodiment apparatus may be configured not to correct a base SOx concentration Csox_base with a correction coefficient Kc. The first embodiment apparatus may also be configured to acquire a correction coefficient Ki_1 for correcting a peak value dIpeak based on an electrode interface resistance Rkai, correct the peak value dIpeak by multiplying the correction coefficient Ki_1 by the peak value dIpeak, acquire a base SOx concentration Csox_base by applying the corrected peak value dIpeak to the look-up table Map1Csox_base(dIpeak), and acquire the base SOx concentration Csox_base as an SOx concentration Csox.

In this case, the correction coefficient Ki_1 is a value larger than or equal to one, and is a value that increases as the electrode interface resistance Rkai increases.

With this configuration as well, the first embodiment apparatus is able to acquire an accurate SOx concentration Csox as an SOx index.

The first embodiment apparatus may be configured not to correct a base SOx concentration Csox_base with a correction coefficient Kc. The first embodiment apparatus may also be configured to correct the look-up table Map1Csox_base(dIpeak) based on an electrode interface resistance Rkai, acquire a base SOx concentration Csox_base by applying a peak value dIpeak to the corrected look-up table Map1Csox_base(dIpeak), and acquire the base SOx concentration Csox_base as an SOx concentration Csox.

An electrode interface resistance Rkai and a solid electrolyte resistance Rden each vary as the temperature of exhaust gas, the flow rate of exhaust gas, components in exhaust gas, or the like, vary or change. Therefore, when an electrode interface resistance Rkai is acquired during operation of the engine 50, the first embodiment apparatus is desirably configured to execute the above-described first voltage variation control and second voltage variation control on condition that the operational status of the engine 50 is a steady state in order to acquire a more accurate electrode interface resistance Rkai.

Alternatively, when the engine 50 is configured to be temporarily stopped at the time when a vehicle including the engine 50 has temporarily stopped, the first embodiment apparatus is desirably configured to execute the above-described first voltage variation control and second voltage variation control on condition that the engine 50 has been temporarily stopped in order to acquire a more accurate electrode interface resistance Rkai.

Alternatively, when the engine 50 is used as an internal combustion engine for a hybrid vehicle that uses the internal combustion engine and an electric motor as vehicle driving sources and the engine 50 is operated or stopped as needed while the vehicle is traveling, the first embodiment apparatus is desirably configured to execute the above-described first voltage variation control and second voltage variation control on condition that the engine 50 has been stopped while the vehicle is traveling in order to acquire a more accurate electrode interface resistance Rkai.

The sensor 10 outputs a stable sensor current Iss when a temperature Tss of the sensor 10 is higher than or equal to an activation temperature Tact. Therefore, in order to acquire a more accurate electrode interface resistance Rkai, the first embodiment apparatus is desirably configured to execute the above-described first voltage variation control and second voltage variation control on condition that the temperature Tss of the sensor 10 is the activation temperature Tact.

The solid electrolyte resistance Rden increases as the temperature Tss of the sensor 10 decreases. Therefore, in order to acquire a more accurate solid electrolyte resistance Rden and, as a result, acquire a more accurate electrode interface resistance Rkai, the first embodiment apparatus is desirably configured to execute the above-described first voltage variation control on condition that the temperature Tss of the sensor 10 is constant or falls within a set range.

Therefore, when the first embodiment apparatus executes the above-described first voltage variation control when the temperature Tss of the sensor 10 is not constant or falls outside a set range, the first embodiment apparatus may be configured to acquire a lower solid electrolyte resistance Rden as the temperature Tss of the sensor 10 decreases.

Next, acquisition of an oxygen concentration will be described. The first embodiment apparatus regularly keeps the sensor voltage Vss at 0.4 V. A voltage of 0.4 V is a voltage higher than or equal to the predetermined value Vth shown in FIG. 3, and is a voltage at which the sensor current Iss is constant irrespective of the sensor voltage Vss when the oxygen concentration in exhaust gas (that is, the exhaust gas air-fuel ratio A/F) is constant. Therefore, when the sensor voltage Vss is kept at 0.4 V, it is possible to acquire an oxygen concentration in exhaust gas (that is, the exhaust gas air-fuel ratio A/F) with a sensor current Iss.

When the first embodiment apparatus keeps the sensor voltage Vss at 0.4 V, the first embodiment apparatus acquires an oxygen concentration Coxy in exhaust gas by applying a sensor current Iss to a look-up table MapCoxy(Iss). According to the table MapCoxy(Iss), as the sensor current Iss increases, a higher oxygen concentration Coxy is acquired.

With this configuration, the first embodiment apparatus is able to acquire an oxygen concentration Coxy in exhaust gas in addition to an SOx concentration Csox in exhaust gas.

The inventors of the present application have found out that the influence of other components (for example, oxygen (O₂) and nitrogen oxides (NOx)) on the sensor current Iss is larger than the influence of SOx on the sensor current Iss when the sensor voltage Vss is kept at a constant voltage (for example, 0.4 V) or the sensor voltage Vss is being increased and the influence of SOx on the sensor current Iss is larger than the influence of other components on the sensor current Iss when the sensor voltage Vss is being decreased from a predetermined voltage (for example, 0.8 V). For this reason, it is possible to accurately acquire an SOx concentration in exhaust gas with the sensor 10 that is able to acquire an oxygen concentration in exhaust gas.

The electrode interface resistance Rkai decreases as the oxygen concentration in exhaust gas coming to the first sensor electrode 15A increases. Therefore, in order to acquire a more accurate electrode interface resistance Rkai, the first embodiment apparatus is desirably configured to acquire a lower electrode interface resistance Rkai as the oxygen concentration Coxy acquired based on the sensor current Iss increases just before the first embodiment apparatus executes the above-described first voltage variation control and second voltage variation control.

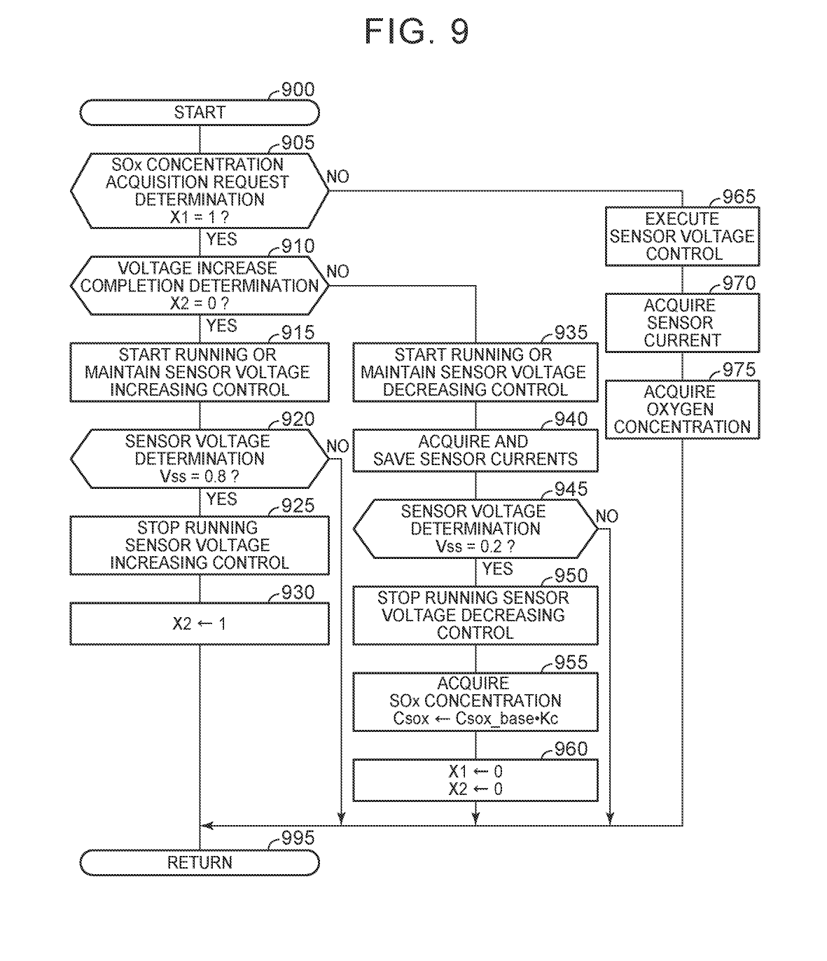

Next, a specific operation of the first embodiment apparatus will be described. The CPU of the sensor ECU 93 of the first embodiment apparatus (hereinafter, simply referred to as CPU) executes the routine shown in FIG. 9 each time a predetermined time elapses.

Therefore, as predetermined timing comes, the CPU starts processing from step 900, proceeds to step 905, and determines whether the value of an SOx concentration acquisition request flag X1 is 1. The value of the SOx concentration acquisition request flag X1 is set to 1 when a request to acquire an SOx concentration has been issued. The value of the SOx concentration acquisition request flag X1 is set to 0 when acquisition of an SOx concentration has completed.

When the value of the SOx concentration acquisition request flag X1 is 1, the CPU makes affirmative determination in step 905, proceeds to step 910, and determines whether the value of a voltage increase completion flag X2 is 0.

Just after a request to acquire an SOx concentration has been issued, the value of the voltage increase completion flag X2 is 0. When the value of the voltage increase completion flag X2 is 0, the CPU makes affirmative determination in step 910, and executes the process of step 915, which will be described below. After that, the CPU proceeds to step 920.

In step 915, the CPU starts running sensor voltage increasing control for increasing the sensor voltage Vss from 0.4 V to 0.8 V when the CPU has not started running the sensor voltage increasing control; whereas the CPU maintains the sensor voltage increasing control when the CPU has already started running the sensor voltage increasing control. When the CPU executes the process of step 915 just after the CPU makes affirmative determination in step 910 for the first time, since the CPU has not started running the sensor voltage increasing control, the CPU starts running the sensor voltage increasing control. After that, the CPU maintains the sensor voltage increasing control until the CPU makes affirmative determination in step 920 (described later).

As the CPU proceeds to step 920, the CPU determines whether the sensor voltage Vss has reached 0.8 V. When the sensor voltage Vss has not reached 0.8 V, the CPU makes negative determination in step 920, proceeds to step 995, and ends the routine.

On the other hand, when the sensor voltage Vss has reached 0.8 V, the CPU makes affirmative determination in step 920, and sequentially executes the processes of step 925 and step 930, which will be described below. After that, the CPU proceeds to step 995, and ends the routine.

In step 925, the CPU stops running the sensor voltage increasing control.

In step 930, the CPU sets the value of the voltage increase completion flag X2 to 1. With this, as the CPU proceeds to step 910 thereafter, the CPU makes negative determination in step 910.

When the value of the voltage increase completion flag X2 is 1 at the time when the CPU executes the process of step 910, the CPU makes negative determination in step 910, and sequentially executes the processes of step 935 and step 940, which will be described below. After that, the CPU proceeds to step 945.

In step 935, the CPU starts running sensor voltage decreasing control for decreasing the sensor voltage Vss from 0.8 V to 0.2 V when the CPU has not started running the sensor voltage decreasing control; whereas the CPU maintains the sensor voltage decreasing control when the CPU has already started running the sensor voltage decreasing control. When the CPU executes the process of step 935 just after the CPU makes negative determination in step 910 for the first time, since the CPU has not started running the sensor voltage decreasing control, the CPU starts running the sensor voltage decreasing control. After that, the CPU maintains the sensor voltage decreasing control until the CPU makes affirmative determination in step 945 (described later).

In step 940, the CPU acquires sensor currents Iss, and saves the sensor currents Iss in the RAM.

As the CPU proceeds to step 940, the CPU determines whether the sensor voltage Vss has reached 0.2 V. When the sensor voltage Vss has not reached 0.2 V, the CPU makes negative determination in step 940, proceeds to step 995, and ends the routine. In this case, the sensor voltage decreasing control is maintained.

On the other hand, when the sensor voltage Vss has reached 0.2 V, the CPU makes affirmative determination in step 945, and sequentially executes the processes of step 950, step 955, and step 960, which will be described below. After that, the CPU proceeds to step 995, and ends the routine.

In step 950, the CPU stops running the sensor voltage decreasing control.

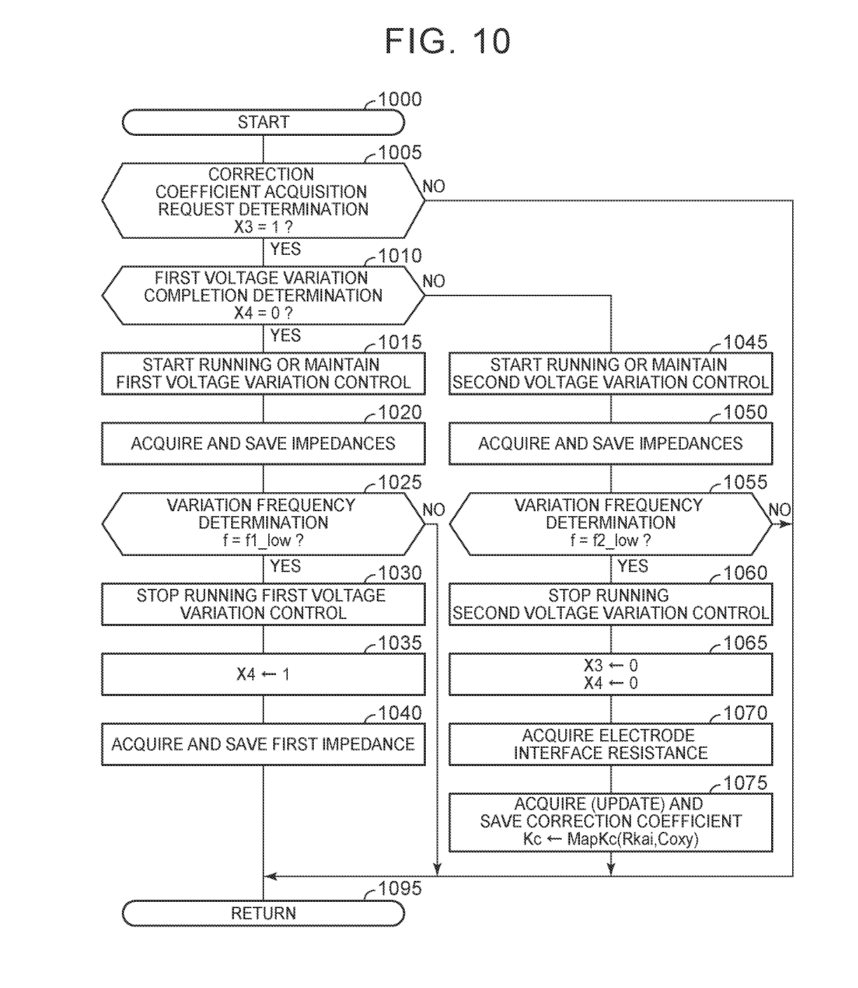

In step 955, the CPU calculates a difference between the reference current Iref and the peak current Ipeak of the sensor current Iss saved in the RAM as a peak value dIpeak, and acquires a base SOx concentration Csox_base by applying the peak value dIpeak to the look-up table Map1Csox_base(dIpeak). The CPU acquires an SOx concentration Csox by multiplying a correction coefficient Kc by the base SOx concentration Csox_base. The correction coefficient Kc is acquired through the routine shown in FIG. 10 (described later), and is saved in the RAM.

In step 960, the CPU sets each of the values of the SOx concentration acquisition request flag X1 and voltage increase completion flag X2 to 0.

When the value of the SOx concentration acquisition request flag X1 is 0 at the time when the CPU executes the process of step 905, the CPU makes negative determination in step 905, and sequentially executes the processes of step 965, step 970, and step 975, which will be described below. After that, the CPU proceeds to step 995, and ends the routine.

In step 965, the CPU executes sensor voltage control for controlling the sensor voltage Vss to 0.4 V. Since the sensor voltage Vss is controlled to 0.2 V just after the CPU stops running the sensor voltage decreasing control, the CPU increases the sensor voltage Vss from 0.2 V to 0.4 V.

In step 970, the CPU acquires a sensor current Iss.

In step 975, the CPU acquires an oxygen concentration Coxy by applying the sensor current Iss acquired in step 970 to the look-up table MapCoxy(Iss).

The CPU executes the routine shown in FIG. 10 each time a predetermined time elapses. Therefore, as predetermined timing comes, the CPU starts processing from step 1000, proceeds to step 1005, and determines whether a correction coefficient acquisition request flag X3 is 1. The value of the correction coefficient acquisition request flag X3 is set to 1 when a request to acquire a correction coefficient Kc has been issued. The value of the correction coefficient acquisition request flag X3 is set to 0 when acquisition of a correction coefficient Kc has completed.

When the value of the correction coefficient acquisition request flag X3 is 0, the CPU makes negative determination in step 1005, proceeds to step 1095, and ends the routine.

On the other hand, when the value of the correction coefficient acquisition request flag X3 is 1, the CPU makes affirmative determination in step 1005, proceeds to step 1010, and determines whether the value of a first voltage variation completion flag X4 is 0. Just after a request to acquire a correction coefficient Kc has been issued, the value of the first voltage variation completion flag X4 is 0.

When the value of the first voltage variation completion flag X4 is 0, the CPU makes affirmative determination in step 1010, and sequentially executes the processes of step 1015 and step 1020, which will be described below. After that, the CPU proceeds to step 1025.

In step 1015, the CPU executes the above-described first voltage variation control. More specifically, the CPU starts running the first voltage variation control when the CPU has not started running the first voltage variation control; whereas the CPU maintains the first voltage variation control when the CPU has already started running the first voltage variation control. After a request to acquire a correction coefficient Kc has been issued, when the CPU makes affirmative determination in step 1010 for the first time, the CPU has not started running the first voltage variation control, so the CPU starts running the first voltage variation control. After that, the CPU maintains the first voltage variation control until the CPU makes affirmative determination in step 1025 (described later).

In step 1020, the CPU acquires impedances Z, and saves the impedances Z in the RAM.

As the CPU proceeds to step 1025, the CPU determines whether the variation frequency f of the sensor voltage Vss has reached the frequency f1_low lower by a predetermined value than the first frequency f1. When the variation frequency f has not reached the frequency f1_low, the CPU makes negative determination in step 1025, proceeds to step 1095, and ends the routine. In this case, the first voltage variation control is maintained.

When the variation frequency f has reached the frequency f1_low, the CPU makes affirmative determination in step 1025, and sequentially executes the processes of step 1030, step 1035, and step 1040, which will be described below. After that, the CPU proceeds to step 1095, and ends the routine.

In step 1030, the CPU stops running the first voltage variation control.

In step 1035, the CPU sets the value of the first voltage variation completion flag X4 to 1. With this, as the CPU proceeds to step 1010 thereafter, the CPU makes negative determination.

In step 1040, the CPU acquires the real part of the impedance Z of which the imaginary part is minimum (nearly zero) from among the impedances Z acquired and saved in the RAM in step 1020 as a first impedance Z1, and saves the first impedance Z1 in the RAM.

When the value of the first voltage variation completion flag X4 is 1 at the time when the CPU executes the process of step 1010, the CPU makes negative determination in step 1010, and sequentially executes the processes of step 1045 and step 1050, which will be described below. After that, the CPU proceeds to step 1055.

In step 1045, the CPU executes the above-described second voltage variation control. More specifically, the CPU starts running the second voltage variation control when the CPU has not started running the second voltage variation control; whereas the CPU maintains the second voltage variation control when the CPU has already started running the second voltage variation control. After a request to acquire a correction coefficient Kc has been issued, when the CPU makes negative determination in step 1010 for the first time, the CPU has not started running the second voltage variation control, so the CPU starts running the second voltage variation control. After that, the CPU maintains the second voltage variation control until the CPU makes affirmative determination in step 1055 (described later).

In step 1050, the CPU acquires an impedance Z and saves the impedance Z in the RAM.

As the CPU proceeds to step 1055, the CPU determines whether the variation frequency f of the sensor voltage Vss has reached the frequency f2_low lower by a predetermined value than the second frequency f2. When the variation frequency f has not reached the frequency f2_low, the CPU makes negative determination in step 1055, proceeds to step 1095, and ends the routine. In this case, the second voltage variation control is maintained.

When the variation frequency f has reached the frequency f2_low, the CPU makes affirmative determination in step 1055, and sequentially executes the processes of step 1060, step 1065, step 1070, and step 1075, which will be described below. After that, the CPU proceeds to step 1095, and ends the routine.

In step 1060, the CPU stops running the second voltage variation control.

In step 1065, the CPU sets each of the values of the correction coefficient acquisition request flag X3 and first voltage variation completion flag X4 to 0.

In step 1070, the CPU acquires the real part of the impedance Z of which the imaginary part is minimum (nearly zero) from among the impedances Z acquired and saved in the RAM in step 1050 as a second impedance Z2. The CPU acquires an electrode interface resistance Rkai by subtracting the first impedance Z1, acquired and saved in the RAM in step 1040, from the second impedance Z2.

In step 1075, the CPU acquires a correction coefficient Kc by applying the electrode interface resistance Rkai acquired in step 1070 and the oxygen concentration Coxy acquired just before the CPU starts running the first voltage variation control in step 1015 to a look-up table MapKc(Rkai,Coxy), and saves the acquired correction coefficient Kc in the RAM.

The specific operation of the first embodiment apparatus is described above. With this, the first embodiment apparatus is able to acquire an SOx concentration Csox and an oxygen concentration Coxy. In addition, the first embodiment apparatus is able to acquire an accurate SOx concentration Csox as an SOx index even when the first sensor electrode 15A degrades.

Next, an SOx index acquisition apparatus for an internal combustion engine according to an alternative embodiment of the first embodiment (hereinafter, referred to as first alternative apparatus) will be described. As described above, an SOx concentration Csox acquired by applying a peak value dIpeak, which is acquired when the first sensor electrode 15A has degraded, to the look-up table Map1Csox_base(dIpeak) is lower than an actual SOx concentration in exhaust gas.

In this regard, the inventors of the present application have found out that the electrical resistance value of the solid electrolyte layer 11 (hereinafter, referred to as solid electrolyte resistance Rden) increases as the degree of degradation of the first sensor electrode 15A increases.

The first alternative apparatus acquires a correction coefficient Kc for correcting a base SOx concentration Csox_base with the solid electrolyte resistance Rden instead of the electrode interface resistance Rkai.

More specifically, as described above, the real part of the first impedance Z1 is a resistance obtained by adding up the resistance R0 of the lead portion, the intraparticle resistance R1 of the solid electrolyte layer 11, and the grain boundary resistance R2 of the solid electrolyte layer 11. Since the resistance R0 of the lead portion is approximately constant, the real part of the first impedance Z1 is a value that correlates with the solid electrolyte resistance Rden.

The first alternative apparatus acquires the real part of a first impedance Z1 as a solid electrolyte resistance Rden, and acquires a correction coefficient Kc by applying the acquired solid electrolyte resistance Rden to a look-up table MapKc(Rden).

As the degree of degradation of the first sensor electrode 15A increases, the solid electrolyte resistance Rden increases, with the result that the passage sensor current Iss for the same SOx concentration increases while the sensor voltage Vss is decreased from 0.8 V to 0.2 V. For this reason, the peak value dIpeak decreases. Therefore, the table MapKc(Rden) is prepared such that a larger correction coefficient Kc is acquired as the solid electrolyte resistance Rden increases. The correction coefficient Kc is a value larger than or equal to one.

The first alternative apparatus acquires an SOx concentration Csox as an SOx index by correcting a base SOx concentration Csox_base by multiplying an acquired correction coefficient Kc by the base SOx concentration Csox_base (Csox=Csox_base·Kc).

The first alternative apparatus acquires an SOx concentration Csox by correcting a base SOx concentration Csox_base with a solid electrolyte resistance Rden that varies in accordance with the degree of degradation of the first sensor electrode 15A. Therefore, the first alternative apparatus is able to acquire an accurate SOx concentration Csox as an SOx index even when the first sensor electrode 15A degrades.

The first alternative apparatus may be configured not to correct a base SOx concentration Csox_base with a correction coefficient Kc. The first alternative apparatus may also be configured to acquire a correction coefficient Ki_1 for correcting a peak value dIpeak based on a solid electrolyte resistance Rden, correct the peak value dIpeak by multiplying the correction coefficient Ki_1 by the peak value dIpeak, and acquire an SOx concentration Csox by applying the corrected peak value dIpeak to the look-up table Map1Csox_base(dIpeak).

In this case, the correction coefficient Ki_1 is a value larger than or equal to one, and is a value that increases as the solid electrolyte resistance Rden increases.

With this configuration as well, the first alternative apparatus is able to acquire an accurate SOx concentration Csox as an SOx index.

The first alternative apparatus may be configured not to correct a base SOx concentration Csox_base with a correction coefficient Kc. The first alternative apparatus may also be configured to correct the look-up table Map1Csox_base(dIpeak) based on a solid electrolyte resistance Rden, and acquire an SOx concentration Csox by applying a peak value dIpeak to the corrected look-up table Map1Csox_base(dIpeak).

The solid electrolyte resistance Rden varies under the influence of the temperature of exhaust gas, the flow rate of exhaust gas, components in exhaust gas, or the like. Therefore, when a solid electrolyte resistance Rden is acquired during operation of the engine 50, the first alternative apparatus is desirably configured to execute the above-described first voltage variation control on condition that the operational status of the engine 50 is a steady state in order to acquire a more accurate solid electrolyte resistance Rden.

Alternatively, when the engine 50 is configured to be temporarily stopped at the time when a vehicle including the engine 50 has temporarily stopped, the first alternative apparatus is desirably configured to execute the above-described first voltage variation control on condition that the engine 50 has been temporarily stopped in order to acquire a more accurate solid electrolyte resistance Rden.

Alternatively, when the engine 50 is used as an internal combustion engine for a hybrid vehicle that uses the internal combustion engine and an electric motor as vehicle driving sources and the engine 50 is operated or stopped as needed while the vehicle is traveling, the first alternative apparatus is desirably configured to execute the above-described first voltage variation control on condition that the engine 50 has been stopped while the vehicle is traveling in order to acquire a more accurate solid electrolyte resistance Rden.

The solid electrolyte resistance Rden increases as the temperature Tss of the sensor 10 decreases. Therefore, in order to acquire a more accurate solid electrolyte resistance Rden, the first alternative apparatus is desirably configured to execute the above-described first voltage variation control on condition that the temperature Tss of the sensor 10 is constant or falls within a set range.

Therefore, when the first alternative apparatus executes the above-described first voltage variation control when the temperature Tss of the sensor 10 is not constant or falls outside a set range, the first alternative apparatus may be configured to acquire a smaller correction coefficient Ki as the temperature Tss of the sensor 10 decreases.

Next, a specific operation of the first alternative apparatus will be described. The CPU of the sensor ECU 93 of the first alternative apparatus (hereinafter, referred to as the CPU of the first alternative apparatus), as in the case of the first embodiment apparatus, executes the routine shown in FIG. 9 each time a predetermined time elapses.

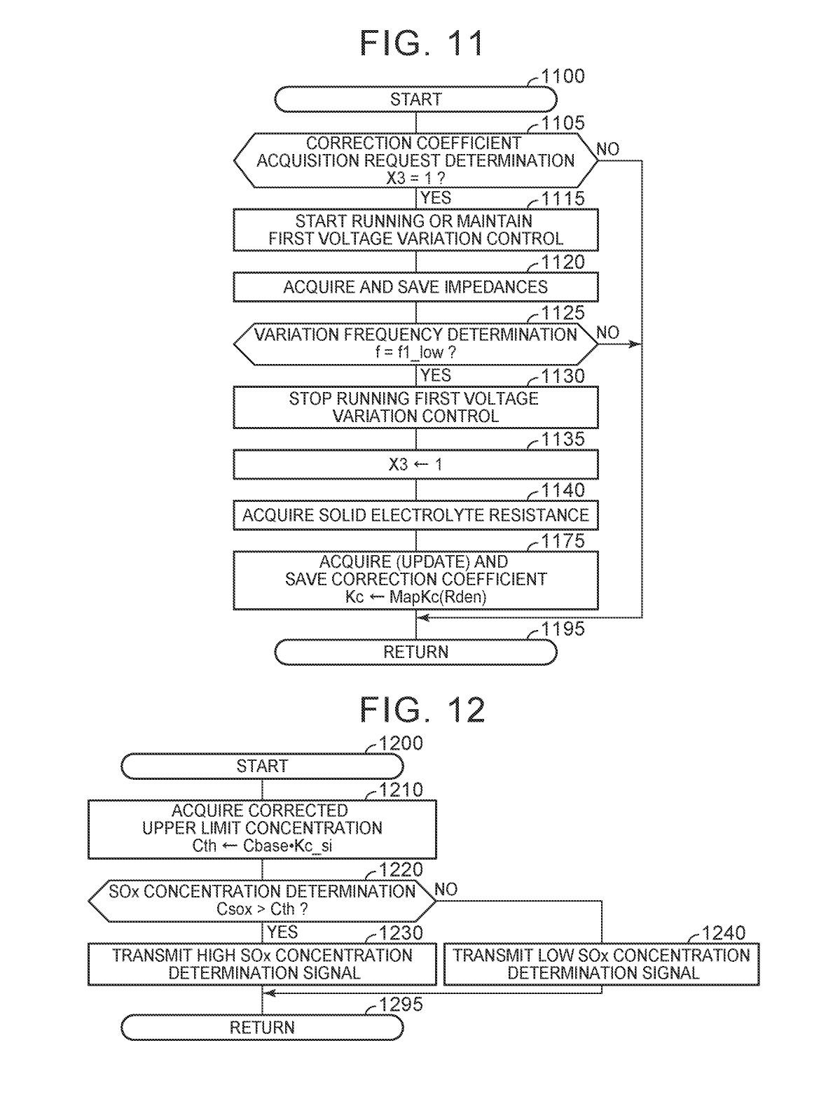

The CPU of the first alternative apparatus executes the routine shown in FIG. 11 each time a predetermined time elapses. Therefore, as predetermined timing comes, the CPU of the first alternative apparatus starts processing from step 1100, proceeds to step 1105, and determines whether the value of the correction coefficient acquisition request flag X3 is 1. The value of the correction coefficient acquisition request flag X3 in the routine shown in FIG. 11 is set to 1 when a request to acquire a correction coefficient Kc has been issued. The value of the correction coefficient acquisition request flag X3 is set to 0 when acquisition of a correction coefficient Kc has completed.

When the value of the correction coefficient acquisition request flag X3 is 0, the CPU of the first alternative apparatus makes negative determination in step 1105, proceeds to step 1195, and ends the routine.

On the other hand, when the value of the correction coefficient acquisition request flag X3 is 1, the CPU of the first alternative apparatus makes affirmative determination in step 1105, and sequentially executes the processes of step 1115 and step 1120, which will be described below. After that, the CPU of the first alternative apparatus proceeds to step 1125.

In step 1115, the CPU of the first alternative apparatus executes the above-described first voltage variation control. More specifically, the CPU of the first alternative apparatus starts running the first voltage variation control when the CPU of the first alternative apparatus has not started running the first voltage variation control; whereas the CPU of the first alternative apparatus maintains the first voltage variation control when the CPU of the first alternative apparatus has already started running the first voltage variation control. After a request to acquire a correction coefficient Kc has been issued, when the CPU of the first alternative apparatus makes affirmative determination in step 1105 for the first time, the CPU of the first alternative apparatus has not started running the first voltage variation control, so the CPU of the first alternative apparatus starts running the first voltage variation control. After that, the CPU of the first alternative apparatus maintains the first voltage variation control until the CPU of the first alternative apparatus makes affirmative determination in step 1125 (described later).

In step 1120, the CPU of the first alternative apparatus acquires impedances Z, and saves the impedances Z in the RAM.

As the CPU of the first alternative apparatus proceeds to step 1125, the CPU of the first alternative apparatus determines whether the variation frequency f of the sensor voltage Vss has reached the frequency f1_low lower by a predetermined value than the first frequency f1. When the variation frequency f has not reached the frequency f1_low, the CPU of the first alternative apparatus makes negative determination in step 1125, proceeds to step 1195, and ends the routine. In this case, the first voltage variation control is maintained.

When the variation frequency f has reached the frequency f1_low, the CPU of the first alternative apparatus makes affirmative determination in step 1125, and sequentially executes the processes of step 1130, step 1135, step 1140, and step 1175, which will be described below. After that, the CPU of the first alternative apparatus proceeds to step 1195, and ends the routine.

In step 1130, the CPU of the first alternative apparatus stops running the first voltage variation control.

In step 1135, the CPU of the first alternative apparatus sets the value of the correction coefficient acquisition request flag X3 to 1. With this, as the CPU of the first alternative apparatus proceeds to step 1105 thereafter, the CPU of the first alternative apparatus makes negative determination.

In step 1140, the CPU of the first alternative apparatus acquires the real part of the impedance Z of which the imaginary part is minimum (nearly zero) (that is, the first impedance Z1) from among the impedances Z acquired and saved in the RAM in step 1120 as a solid electrolyte resistance Rden.

In step 1175, the CPU of the first alternative apparatus acquires a correction coefficient Kc by applying the solid electrolyte resistance Rden acquired in step 1140 to the look-up table MapKc(Rden), and saves the acquired correction coefficient Kc in the RAM.

The specific operation of the first alternative apparatus is described above. With this, the first alternative apparatus is able to acquire an SOx concentration Csox and an oxygen concentration Coxy. In addition, the first alternative apparatus is able to acquire an accurate SOx concentration Csox as an SOx index even when the first sensor electrode 15A degrades.

Next, an SOx index acquisition apparatus for an internal combustion engine according to a second embodiment of the disclosure (hereinafter, referred to as second embodiment apparatus) will be described.

When an SOx concentration in exhaust gas is a concentration lower than or equal to an upper limit concentration Csox limit stipulated by law, or the like, but is a concentration close to the upper limit concentration Csox limit, it is advantageous in determining whether the SOx concentration in exhaust gas is close to the upper limit concentration Csox limit in order to issue an alarm, or the like, for informing that the SOx concentration in exhaust gas is close to the upper limit concentration Csox limit.

The second embodiment apparatus prescribes and stores an allowable upper limit of an SOx concentration (hereinafter, referred to as allowable upper limit concentration) in exhaust gas when the first sensor electrode 15A has not degraded (that is, when the electrode interface resistance Rkai is a predetermined value), as a base upper limit concentration Cbase.

The second embodiment apparatus acquires a correction coefficient Kc_si for correcting the base upper limit concentration Cbase in accordance with the degree of degradation of the first sensor electrode 15A, acquires a corrected upper limit concentration Cth by correcting the base upper limit concentration Cbase with the correction coefficient Kc_si, determines whether an SOx concentration in exhaust gas is higher than the allowable upper limit concentration by using the corrected upper limit concentration Cth, and acquires the determination result as an SOx index.

More specifically, as the degree of degradation of the first sensor electrode 15A increases, a base SOx concentration Csox_base acquired by applying a peak value dIpeak to the look-up table Map1Csox_base(dIpeak) decreases. Therefore, in order to acquire an accurate determination result as to whether an SOx concentration in exhaust gas is higher than the allowable upper limit concentration, it is required to correct the base upper limit concentration Cbase such that the base upper limit concentration Cbase decreases as the degree of degradation of the first sensor electrode 15A increases.

The second embodiment apparatus acquires an electrode interface resistance Rkai, and acquires a correction coefficient Kc_si by applying the acquired electrode interface resistance Rkai to a look-up table MapKc_si(Rkai). The table MapKc_si(Rkai) is prepared such that a smaller correction coefficient Kc_si is acquired as the electrode interface resistance Rkai increases. The correction coefficient Kc_si is a value larger than zero and smaller than or equal to one.

The second embodiment apparatus acquires a corrected upper limit concentration Cth by correcting a base upper limit concentration Cbase by multiplying the correction coefficient Kc_si by the base upper limit concentration Cbase (Cth=Cbase·Kc_si).

The second embodiment apparatus acquires the base SOx concentration Csox_base, acquired by applying a peak value dIpeak to the look-up table Map1Csox_base(dIpeak), as an SOx concentration Csox. The second embodiment apparatus determines whether the SOx concentration Csox is higher than the corrected upper limit concentration Cth. When the SOx concentration Csox is higher than the corrected upper limit concentration Cth, the second embodiment apparatus acquires a determination result that the SOx concentration in exhaust gas is higher than the allowable upper limit concentration. On the other hand, when the SOx concentration Csox is lower than or equal to the corrected upper limit concentration Cth, the second embodiment apparatus acquires a determination result that the SOx concentration in exhaust gas is lower than or equal to the allowable upper limit concentration.

With this configuration, the second embodiment apparatus acquires a corrected upper limit concentration Cth by correcting a base upper limit concentration Cbase with an electrode interface resistance Rkai that varies in accordance with the degree of degradation of the first sensor electrode 15A, and acquires a determination result as to whether an SOx concentration in exhaust gas is higher than the allowable upper limit concentration by using the corrected upper limit concentration Cth. Therefore, even when the first sensor electrode 15A degrades, the second embodiment apparatus is able to acquire an accurate determination result as to whether an SOx concentration in exhaust gas is higher than the allowable upper limit concentration, as an SOx index.

The second embodiment apparatus may also be configured to acquire a determination result as to whether an SOx concentration in exhaust gas is higher than the allowable upper limit concentration by using a peak value dIpeak.

In this case, the second embodiment apparatus prescribes and stores a peak value dIpeak corresponding to a base upper limit concentration Cbase as a base upper limit current (in other words, base determination current) Ibase_1.

The second embodiment apparatus acquires a correction coefficient Ki_si_1 by applying an electrode interface resistance Rkai to a look-up table MapKi_si_1(Rkai). The table MapKi_si_1(Rkai) is prepared such that a smaller correction coefficient Ki_si_1 is acquired as the electrode interface resistance Rkai increases. The correction coefficient Ki_si_1 is a value larger than zero and smaller than or equal to one.

The second embodiment apparatus acquires a corrected upper limit current (in other words, corrected determination current) Ith_1 by correcting a base upper limit current Ibase_1 by multiplying the acquired correction coefficient Ki_si_1 by the base upper limit current Ibase_1(Ith_1=Ibase_1·Ki_si_1).

The second embodiment apparatus determines whether a peak value dIpeak is larger than the corrected upper limit current Ith_1. When the peak value dIpeak is larger than the corrected upper limit current Ith_1, the second embodiment apparatus acquires a determination result that the SOx concentration in exhaust gas is higher than the allowable upper limit concentration. In contrast, when the peak value dIpeak is smaller than or equal to the corrected upper limit current Ith_1, the second embodiment apparatus acquires a determination result that the SOx concentration in exhaust gas is lower than or equal to the allowable upper limit concentration.

With this configuration as well, even when the first sensor electrode 15A degrades, the second embodiment apparatus is able to acquire an accurate determination result as to whether an SOx concentration in exhaust gas is higher than the allowable upper limit concentration, as an SOx index.

The second embodiment apparatus may also be configured to acquire an SOx concentration Csox by correcting a base SOx concentration Csox_base based on an electrode interface resistance Rkai or a solid electrolyte resistance Rden, and acquire a high SOx concentration determination result by determining whether the SOx concentration Csox is higher than a base upper limit concentration Cbase.

The second embodiment apparatus may also be configured to correct a peak value dIpeak based on an electrode interface resistance Rkai or a solid electrolyte resistance Rden, and acquire a high SOx concentration determination result by determining whether the corrected peak value dIpeak is higher than a base upper limit current Ibase.

Next, a specific operation of the second embodiment apparatus will be described. The CPU of the sensor ECU 93 of the second embodiment apparatus (hereinafter, referred to as the CPU of the second embodiment apparatus), as in the case of the first embodiment apparatus, executes the routine shown in FIG. 9 each time a predetermined time elapses.

However, when the CPU of the second embodiment apparatus executes the routine shown in FIG. 9, the CPU of the second embodiment apparatus calculates a difference between the reference current Iref and the peak current Ipeak of the sensor current Iss saved in the RAM as a peak value dIpeak and acquires a base SOx concentration Csox_base by applying the peak value dIpeak to the look-up table Map1Csox_base(dIpeak) in step 955 of FIG. 9. The CPU of the second embodiment apparatus saves the acquired base SOx concentration Csox_base in the RAM as an SOx concentration Csox.

The CPU of the second embodiment apparatus, as in the case of the first embodiment apparatus, executes the routine shown in FIG. 10 each time a predetermined time elapses.

However, when the CPU of the second embodiment apparatus executes the routine shown in FIG. 10, the correction coefficient acquisition request flag X3 is set to 1 when a request to acquire a correction coefficient Kc_si has been issued, and is set to 0 when acquisition of a correction coefficient Kc_si has completed.

The CPU of the second embodiment apparatus acquires a correction coefficient Kc_si by applying the electrode interface resistance Rkai acquired in step 1070 to the look-up table MapKc_si(Rkai), and saves the acquired correction coefficient Kc_si in the RAM in step 1075 of FIG. 10.

The CPU of the second embodiment apparatus executes the routine shown by the flowchart in FIG. 12 each time a predetermined time elapses. Therefore, as predetermined timing comes, the CPU of the second embodiment apparatus starts processing from step 1200 of FIG. 12, proceeds to step 1210, and acquires a corrected upper limit concentration Cth by multiplying the correction coefficient Kc_si by the base upper limit concentration Cbase.

Subsequently, the CPU of the second embodiment apparatus proceeds to step 1220, and determines whether the SOx concentration Csox is higher than the corrected upper limit concentration Cth acquired in step 1210.

When the SOx concentration Csox is higher than the corrected upper limit concentration Cth, the CPU of the second embodiment apparatus makes affirmative determination in step 1220, proceeds to step 1230, and transmits a signal representing a determination result that the SOx concentration in exhaust gas is higher than the allowable upper limit concentration (high SOx concentration determination signal) to the electronic control unit 90. After that, the CPU of the second embodiment apparatus proceeds to step 1295, and ends the routine.

In contrast, when the SOx concentration Csox is lower than or equal to the corrected upper limit concentration Cth, the CPU of the second embodiment apparatus makes negative determination in step 1220, proceeds to step 1240, and transmits a signal representing a determination result that the SOx concentration in exhaust gas is lower than or equal to the allowable upper limit concentration (low SOx concentration determination signal) to the electronic control unit 90. After that, the CPU of the second embodiment apparatus proceeds to step 1295, and ends the routine.

The specific operation of the second embodiment apparatus is described above. With this configuration, even when the first sensor electrode 15A degrades, the second embodiment apparatus is able to acquire an accurate determination result as to whether an SOx concentration in exhaust gas is higher than the allowable upper limit concentration, as an SOx index.

Next, an SOx index acquisition apparatus for an internal combustion engine according to an alternative embodiment of the second embodiment (hereinafter, referred to as second alternative apparatus) will be described. As described above, the inventors of the present application have found out that a solid electrolyte resistance Rden increases as the degree of degradation of the first sensor electrode 15A increases.

The second alternative apparatus acquires a correction coefficient Kc_si for correcting a base upper limit concentration Cbase with the solid electrolyte resistance Rden instead of the electrode interface resistance Rkai.

More specifically, the second alternative apparatus acquires the real part of a first impedance Z1 as a solid electrolyte resistance Rden, and acquires a correction coefficient Kc_si by applying the acquired solid electrolyte resistance Rden to a look-up table MapKc_si(Rden).

As the degree of degradation of the first sensor electrode 15A of the sensor 10 increases, a base SOx concentration Csox_base that is acquired by applying a peak value dIpeak to the look-up table Map1Csox_base(dIpeak) decreases. Therefore, the look-up table MapKc_si(Rden) for acquiring a correction coefficient Kc_si is prepared such that a smaller correction coefficient Kc_si is acquired as the solid electrolyte resistance Rden increases. The correction coefficient Kc_si is a value larger than zero and smaller than or equal to one.

The second alternative apparatus, as well as the second embodiment apparatus, acquires a corrected upper limit concentration Cth by correcting a base upper limit concentration Cbase with the acquired correction coefficient Kc_si, determines whether an SOx concentration in exhaust gas is higher than the allowable upper limit concentration by using the corrected upper limit concentration Cth, and acquires the determination result (hereinafter, referred to as high SOx concentration determination result) as an SOx index.

The second alternative apparatus acquires a corrected upper limit concentration Cth by correcting a base upper limit concentration Cbase with a solid electrolyte resistance Rden that varies in accordance with the degree of degradation of the first sensor electrode 15A, and acquires a high SOx concentration determination result by using the corrected upper limit concentration Cth. Therefore, even when the first sensor electrode 15A degrades, the second alternative apparatus is able to acquire an accurate high SOx concentration determination result as an SOx index.

The second alternative apparatus may also be configured to acquire a high SOx concentration determination result by using a peak value dIpeak.

In this case, the second alternative apparatus prescribes and stores a peak value dIpeak corresponding to a base upper limit concentration Cbase as a base upper limit current (in other words, base determination current) Ibase_1.

The second alternative apparatus acquires a correction coefficient Ki_si_1 by applying a solid electrolyte resistance Rden to a look-up table MapKi_si_1(Rden). The table MapKi_si_1(Rden) is prepared such that a smaller correction coefficient Ki_si_1 is acquired as the solid electrolyte resistance Rden increases. The correction coefficient Ki_si_1 is a value larger than zero and smaller than or equal to one.

The second alternative apparatus acquires a corrected upper limit current (in other words, corrected determination current) Ith_1 by correcting the base upper limit current Ibase_1 by multiplying the acquired correction coefficient Ki_si_1 by the base upper limit current Ibase_1 (Ith_1=Ibase_1·Ki_si_1).

The second alternative apparatus determines whether a peak value dIpeak is larger than the corrected upper limit current Ith_1. When the peak value dIpeak is larger than the corrected upper limit current Ith_1, the second alternative apparatus acquires a determination result that the SOx concentration in exhaust gas is higher than the allowable upper limit concentration. In contrast, when the peak value dIpeak is smaller than or equal to the corrected upper limit current Ith_1, the second alternative apparatus acquires a determination result that the SOx concentration in exhaust gas is lower than or equal to the allowable upper limit concentration.

With this configuration as well, even when the first sensor electrode 15A degrades, the second alternative apparatus is able to acquire an accurate high SOx concentration determination result as an SOx index.

Next, a specific operation of the second alternative apparatus will be described. The CPU of the sensor ECU 93 of the second alternative apparatus (hereinafter, referred to as the CPU of the second alternative apparatus), as in the case of the second embodiment apparatus, executes the routine shown in FIG. 9 each time a predetermined time elapses.

The CPU of the second alternative apparatus, as in the case of the first alternative apparatus, executes the routine shown in FIG. 11 each time a predetermined time elapses.

However, when the CPU of the second alternative apparatus executes the routine shown in FIG. 11, the CPU of the second alternative apparatus acquires a correction coefficient Kc_si by applying the solid electrolyte resistance Rden acquired in step 1140 to the look-up table MapKc_si(Rden), and saves the acquired correction coefficient Kc_si in the RAM in step 1175.

The CPU of the second alternative apparatus, as in the case of the second embodiment apparatus, executes the routine shown in FIG. 12 each time a predetermined time elapses.

The specific operation of the second alternative apparatus is described above. With this configuration, even when the first sensor electrode 15A degrades, the second alternative apparatus is able to acquire an accurate high SOx concentration determination result as an SOx index.

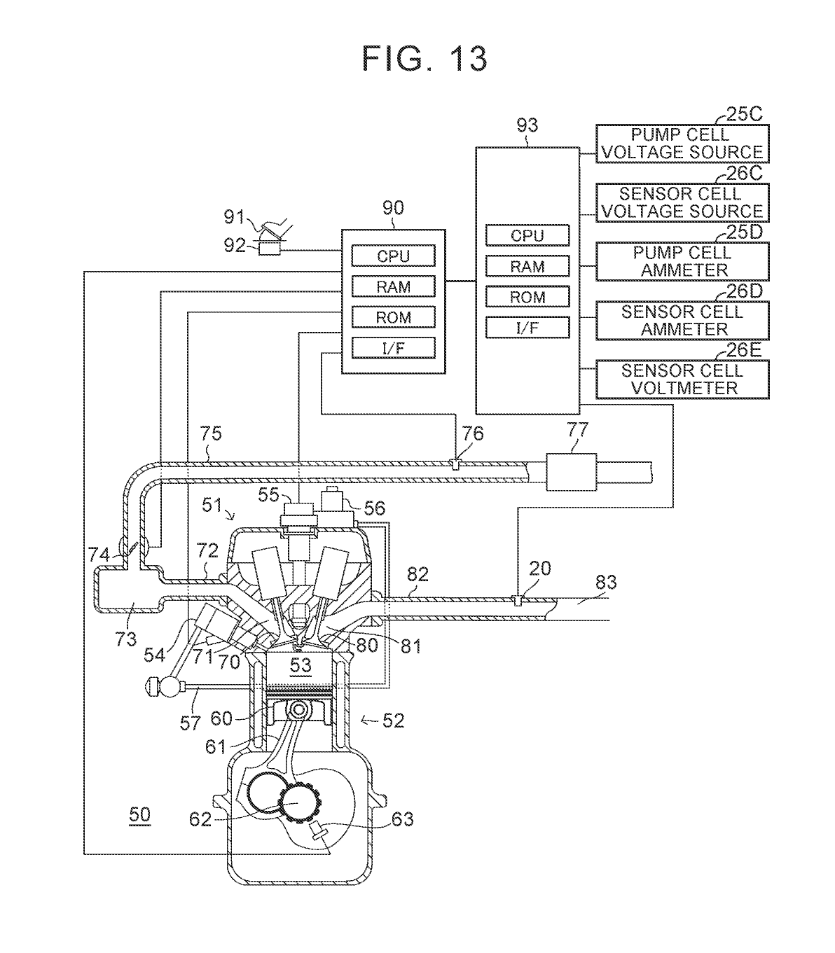

Next, an SOx index acquisition apparatus for an internal combustion engine according to a third embodiment of the disclosure (hereinafter, referred to as third embodiment apparatus) will be described. The third embodiment apparatus is applied to an internal combustion engine shown in FIG. 13. The internal combustion engine shown in FIG. 13 is the same as the internal combustion engine shown in FIG. 1.

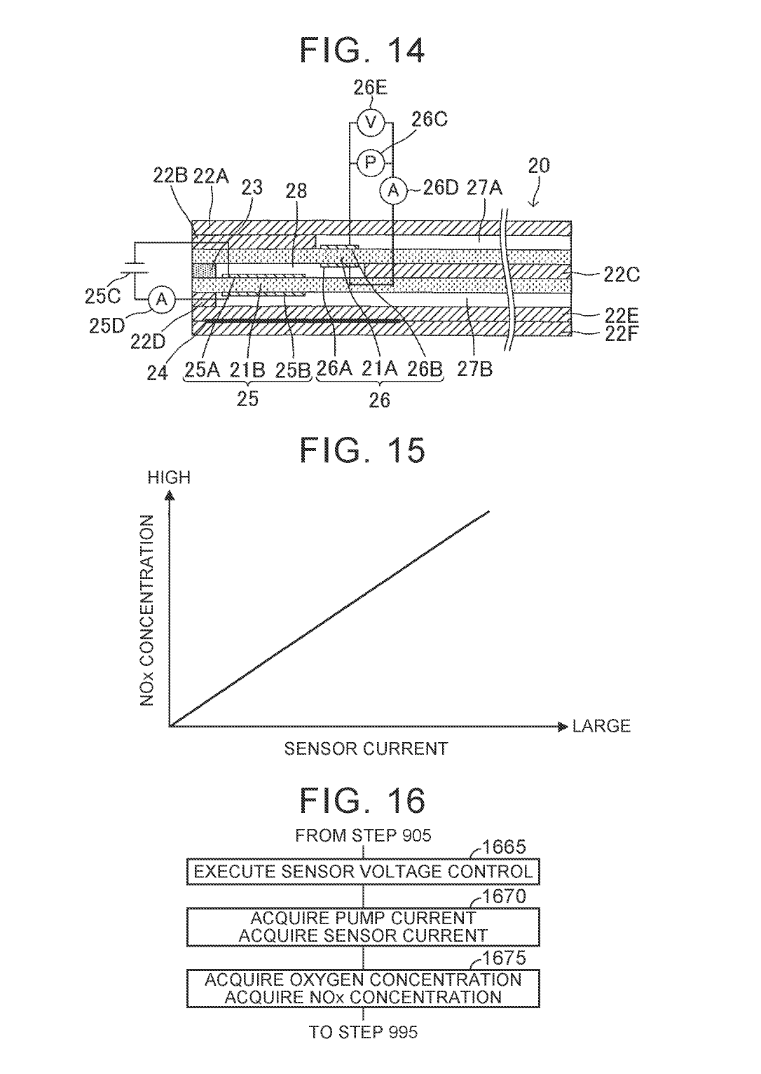

The third embodiment apparatus includes a limiting current sensor 20, a pump cell voltage source 25C, a sensor cell voltage source 26C, an ammeter 25D, an sensor cell ammeter 26D, a sensor cell voltmeter 26E, and the sensor ECU 93. The limiting current sensor 20 has an internal structure shown in FIG. 14. The limiting current sensor 20 is a two cell-type limiting current sensor. The limiting current sensor 20 is disposed in the exhaust pipe 83.

As shown in FIG. 14, the sensor 20 includes a first alumina layer 22A, a second alumina layer 22B, a third alumina layer 22C, a fourth alumina layer 22D, a fifth alumina layer 22E, a sixth alumina layer 22F, a diffusion-controlling layer 23, a heater 24, a pump cell 25, a sensor cell 26, a first atmosphere introducing passage 27A, a second atmosphere introducing passage 27B, and an internal space 28. The pump cell 25 includes a second solid electrolyte layer 21B, a first pump electrode 25A, and a second pump electrode 25B. The sensor cell 26 includes a first solid electrolyte layer 21A, a first sensor electrode 26A, and a second sensor electrode 26B.

Each of the solid electrolyte layers 21A, 21B is a layer made of zirconia, and the like. Each of the solid electrolyte layers 21A, 21B has an oxygen ion conductivity. Each of the alumina layers 22A, 22B, 22C, 22D, 22E, 22F is a layer made of alumina. The diffusion-controlling layer 23 is a porous layer. The diffusion-controlling layer 23 allows exhaust gas to pass therethrough. In the sensor 20, the layers are laminated in order of the sixth alumina layer 22F, the fifth alumina layer 22E, the fourth alumina layer 22D, the second solid electrolyte layer 21B, the diffusion-controlling layer 23 and third alumina layer 22C, the first solid electrolyte layer 21A, the second alumina layer 22B, and the first alumina layer 22A from the bottom in FIG. 14. The heater 24 is disposed between the fifth alumina layer 22E and the sixth alumina layer 22F.

The first atmosphere introducing passage 27A is a space defined by the first alumina layer 22A, the second alumina layer 22B, and the first solid electrolyte layer 21A. Part of the first atmosphere introducing passage 27A is open to the atmosphere. The second atmosphere introducing passage 27B is a space defined by the second solid electrolyte layer 21B, the fourth alumina layer 22D, and the fifth alumina layer 22E. Part of the second atmosphere introducing passage 27B is open to the atmosphere. The internal space 28 is a space defined by the first solid electrolyte layer 21A, the second solid electrolyte layer 21B, the diffusion-controlling layer 23, and the third alumina layer 22C. Part of the internal space 28 communicates with the outside of the sensor 20 via the diffusion-controlling layer 23.

Each of the first pump electrode 25A and the second pump electrode 25B is an electrode made of a material having low reducing properties (for example, an alloy of gold and platinum). The first pump electrode 25A is disposed on a first-side surface of the second solid electrolyte layer 21B (that is, a wall surface of the second solid electrolyte layer 21B, which defines the internal space 28). The second pump electrode 25B is disposed on a second-side surface of the second solid electrolyte layer 21B (that is, a wall surface of the second solid electrolyte layer 21B, which defines the second atmosphere introducing passage 27B). These electrodes 25A, 25B and second solid electrolyte layer 21B constitute the pump cell 25.

The sensor 20 is configured to be able to apply a voltage from the pump cell voltage source 25C to the pump cell 25 (specifically, between the first pump electrode 25A and the second pump electrode 25B). The first pump electrode 25A is a cathode electrode, and the second pump electrode 25B is an anode electrode.

As a voltage is applied to the pump cell 25, oxygen in the internal space 28 is ionized into oxygen ions on the first pump electrode 25A when the oxygen comes into contact with the first pump electrode 25A, and the oxygen ions migrate toward the second pump electrode 25B through the second solid electrolyte layer 21B. At this time, a current proportional to the amount of oxygen ions migrated through the second solid electrolyte layer 21B passes between the first pump electrode 25A and the second pump electrode 25B. As the oxygen ions reach the second pump electrode 25B, the oxygen ions become oxygen on the second pump electrode 25B, and the oxygen is released to the second atmosphere introducing passage 27B. That is, the pump cell 25 is able to decrease an oxygen concentration in exhaust gas by releasing oxygen from the exhaust gas by means of pumping. The pumping capacity of the pump cell 25 increases as the voltage that is applied from the pump cell voltage source 25C to the pump cell 25 increases.

Each of the first sensor electrode 26A and the second sensor electrode 26B is an electrode made of a material having high reducing properties (for example, an element of the platinum group, such as platinum and rhodium, or an alloy of an element of the platinum group). The first sensor electrode 26A is disposed on a first-side wall surface of the first solid electrolyte layer 21A (that is, a wall surface of the first solid electrolyte layer 21A, which defines the internal space 28). The second sensor electrode 26B is disposed on a second-side wall surface of the first solid electrolyte layer 21A (that is, a wall surface of the first solid electrolyte layer 21A, which defines the first atmosphere introducing passage 27A). These electrodes 26A, 26B and first solid electrolyte layer 21A constitute the sensor cell 26.

The sensor 20 is configured to be able to apply a voltage from the sensor cell voltage source 26C to the sensor cell 26 (specifically, between the first sensor electrode 26A and the second sensor electrode 26B). The sensor cell voltage source 26C is configured to be able to selectively apply a direct-current voltage or alternating-current voltage to the sensor cell 26. When the sensor cell voltage source 26C applies a direct-current voltage to the sensor cell 26, the first sensor electrode 26A is a cathode electrode, and the second sensor electrode 26B is an anode electrode.

As a voltage is applied to the sensor cell 26, SOx in the internal space 28 are decomposed on the first sensor electrode 26A when the SOx come into contact with the first sensor electrode 26A, oxygen in the SOx is ionized into oxygen ions, and the oxygen ions migrate toward the second sensor electrode 26B through the first solid electrolyte layer 21A. At this time, a current proportional to the amount of oxygen ions migrated through the first solid electrolyte layer 21A passes between the first sensor electrode 26A and the second sensor electrode 26B. As the oxygen ions reach the second sensor electrode 26B, the oxygen ions become oxygen on the second sensor electrode 26B, and the oxygen is released to the first atmosphere introducing passage 27A.

The heater 24, the pump cell voltage source 25C, the sensor cell voltage source 26C, the ammeter 25D, the sensor cell ammeter 26D, and the sensor cell voltmeter 26E are connected to the sensor ECU 93.

The sensor ECU 93 controls the operation of the heater 24 such that the temperature of the sensor cell 26 is kept at a predetermined constant temperature (that is, sensor activation temperature).

The sensor ECU 93 also controls the voltage of the pump cell voltage source 25C such that a voltage that is set as will be described later is applied from the pump cell voltage source 25C to the pump cell 25.

The sensor ECU 93 also controls the voltage of the sensor cell voltage source 26C such that a voltage that is set as will be described later is applied from the sensor cell voltage source 26C to the sensor cell 26.

The ammeter 25D detects a current Ipp passing through a circuit including the pump cell 25 (hereinafter, referred to as pump current Ipp), and outputs a signal representing the detected pump current Ipp to the sensor ECU 93. The sensor ECU 93 acquires a pump current Ipp based on the signal.

The sensor cell ammeter 26D detects a current Iss passing through a circuit including the sensor cell 26 (hereinafter, referred to as sensor current Iss), and outputs a signal representing the detected sensor current Iss to the sensor ECU 93. The sensor ECU 93 acquires a sensor current Iss based on the signal.

The sensor cell voltmeter 26E detects a voltage Vss that is applied to the sensor cell 26 (hereinafter, referred to as sensor voltage Vss), and outputs a signal representing the detected sensor voltage Vss to the sensor ECU 93. The sensor ECU 93 acquires a sensor voltage Vss based on the signal.

Next, the outline of the operation of the third embodiment apparatus will be described. Initially, acquisition of an SOx concentration will be described. The inventors of the present application have found out that, with regard to the sensor 20 as well, when the sensor voltage Vss is increased from 0.4 V to 0.8 V and then decreased from 0.8 V to 0.2 V while the voltage Vpp that decreases an oxygen concentration in exhaust gas in the internal space 28 to zero (or nearly zero) is applied to the pump cell 25, a peak current Ipeak that correlates with an SOx concentration Csox is output from the sensor cell 26 while the sensor voltage Vss is being decreased from 0.8 V to 0.2 V.

The third embodiment apparatus keeps the sensor voltage Vss at 0.4 V in a state where the voltage Vpp that decreases an oxygen concentration in exhaust gas in the internal space 28 to zero (or nearly zero) is applied to the pump cell 25. The third embodiment apparatus increases the sensor voltage Vss from 0.4 V to 0.8 V such that the rate of increase in sensor voltage Vss gradually decreases, and, after that, decreases the sensor voltage Vss from 0.8 V to 0.2 V such that the rate of decrease in sensor voltage Vss gradually increases.

The third embodiment apparatus acquires a base SOx concentration Csox_base by applying a peak value dIpeak (=|Iref−Iss|) to a look-up table Map2Csox_base(dIpeak). The peak value dIpeak is acquired while the sensor voltage Vss is decreased from 0.8 V to 0.2 V. The third embodiment apparatus acquires an SOx concentration Csox by correcting the base SOx concentration Csox_base with a correction coefficient Kc (described later). The SOx concentration Csox is an SOx index. According to the table Map2Csox_base(dIpeak), as the peak value dIpeak increases, a higher base SOx concentration Csox_base is acquired.

Next, correction of an SOx concentration will be described. Incidentally, the material that constitutes the first sensor electrode 26A of the third embodiment apparatus can possibly be sintered under the influence of the heat of exhaust gas, or the like, and degrade, as in the case of the first sensor electrode 15A of the first embodiment apparatus.

The third embodiment apparatus also acquires an electrode interface resistance Rkai at an interface between the first sensor electrode 26A and the solid electrolyte layer 21A, acquires a correction coefficient Kc for correcting a base SOx concentration Csox_base based on the electrode interface resistance Rkai, and acquires an SOx concentration Csox by correcting the base SOx concentration Csox_base with the correction coefficient Kc.

More specifically, the third embodiment apparatus executes first voltage variation control. In the first voltage variation control, the sensor voltage Vss is varied so as to form a sine wave with 0 V as its center, and the variation frequency f of the sensor voltage Vss is varied so as to gradually decrease from a frequency f1_high higher by a predetermined value than a predetermined first frequency f1 to a frequency f1_low lower by a predetermined value than the first frequency f1.

The third embodiment apparatus acquires impedances Z based on sensor voltages Vss and sensor currents Iss, acquired during the first voltage variation control. The third embodiment apparatus acquires the real part of the impedance Z of which the imaginary part is minimum (zero or nearly zero) from among the acquired impedances Z as the first impedance Z1.

The third embodiment apparatus also executes second voltage variation control. In the second voltage variation control, the sensor voltage Vss is varied so as to form a sine wave with 0 V as its center, and the variation frequency f of the sensor voltage Vss is varied so as to gradually decrease from a frequency f2_high higher by a predetermined value than a predetermined second frequency f2 lower than the first frequency f1 to a frequency f2_low lower by a predetermined value than the second frequency f2. The frequency f2_high is a frequency lower than the frequency f1_low.

The third embodiment apparatus acquires impedances Z based on sensor voltages Vss and sensor currents Iss, acquired during the second voltage variation control. The third embodiment apparatus acquires the real part of the impedance Z of which the imaginary part is minimum (zero or nearly zero) from among the acquired impedances Z as the second impedance Z2.

The third embodiment apparatus acquires an electrode interface resistance Rkai by subtracting the first impedance Z1 from the second impedance Z2 (Rkai=Z2−Z1). The third embodiment apparatus acquires a correction coefficient Kc by applying the acquired electrode interface resistance Rkai to the look-up table MapKc(Rkai).

As the degree of degradation of the first sensor electrode 26A increases, the electrode interface resistance Rkai increases, with the result that the passage sensor current Iss for the same SOx concentration increases while the sensor voltage Vss is decreased from 0.8 V to 0.2 V. For this reason, the peak value dIpeak decreases. Therefore, the table MapKc(Rkai) is prepared such that a larger correction coefficient Kc is acquired as the electrode interface resistance Rkai increases. The correction coefficient Kc is a value larger than or equal to one.

The third embodiment apparatus acquires an SOx concentration Csox by multiplying the correction coefficient Kc by the base SOx concentration Csox_base (Csox=Csox_base·Kc).

The third embodiment apparatus acquires an SOx concentration Csox by correcting the base SOx concentration Csox_base with the electrode interface resistance Rkai that varies in accordance with the degree of degradation of the first sensor electrode 26A. Therefore, the third embodiment apparatus is able to acquire an accurate SOx concentration Csox as an SOx index even when the first sensor electrode 26A degrades.

The third embodiment apparatus may be configured not to correct a base SOx concentration Csox_base with a correction coefficient Kc. The third embodiment apparatus may also be configured to acquire a correction coefficient Ki_2 for correcting a peak value dIpeak based on an electrode interface resistance Rkai, correct the peak value dIpeak by multiplying the correction coefficient Ki_2 by the peak value dIpeak, acquire a base SOx concentration Csox_base by applying the corrected peak value dIpeak to the look-up table Map2Csox_base(dIpeak), and acquire the base SOx concentration Csox_base as an SOx concentration Csox.

In this case, the correction coefficient Ki_2 is a value larger than or equal to one, and is a value that increases as the electrode interface resistance Rkai increases.

With this configuration as well, the third embodiment apparatus is able to acquire an accurate SOx concentration Csox as an SOx index.

The third embodiment apparatus may be configured not to correct a base SOx concentration Csox_base with a correction coefficient Kc. The third embodiment apparatus may also be configured to correct the look-up table Map2Csox_base(dIpeak) based on an electrode interface resistance Rkai, acquire a base SOx concentration Csox_base by applying a peak value dIpeak to the corrected look-up table Map2Csox_base(dIpeak), and acquire the base SOx concentration Csox_base as an SOx concentration Csox.

As described above, the electrode interface resistance Rkai decreases as the oxygen concentration in exhaust gas coming to the first sensor electrode 26A increases. However, in the third embodiment apparatus, since an oxygen concentration in exhaust gas coming to the first sensor electrode 26A is kept constant, it is not required to correct the electrode interface resistance Rkai based on an oxygen concentration in exhaust gas.

Next, acquisition of an NOx concentration will be described. When nitrogen oxides (hereinafter, referred to as NOx) are contained in exhaust gas, NOx are reduced by the sensor cell 26 and decomposed into nitrogen and oxygen when the sensor voltage Vss is kept at 0.4 V. Oxygen produced as a result of decomposition of NOx is ionized into oxygen ions at the sensor cell 26, and the oxygen ions migrate toward the second sensor electrode 26B through the solid electrolyte layer 21A.

Even when the voltage Vpp that decreases an oxygen concentration in exhaust gas in the internal space 28 to zero (or nearly zero) is being applied to the pump cell 25, since each of the pump electrodes 25A, 25B that constitute the pump cell 25 is made of a material having low reducing properties, NOx in exhaust gas are almost not reduced at the pump cell 25. When the voltage Vpp that decreases an oxygen concentration in exhaust gas in the internal space 28 to zero (or nearly zero) is being applied to the pump cell 25, almost no oxygen is contained in exhaust gas coming to the sensor cell 26.

Therefore, a sensor current Iss that is output in proportion to the amount of oxygen ions migrated through the solid electrolyte layer 21A when the voltage Vpp that decreases an oxygen concentration in exhaust gas in the internal space 28 to zero (or nearly zero) is being applied to the pump cell 25 and the sensor voltage Vss is kept at 0.4 V is a current proportional to an NOx concentration in exhaust gas. There is the relation shown in FIG. 15 between a sensor current Iss and an NOx concentration in exhaust gas at this time. Therefore, it is possible to acquire an NOx concentration in exhaust gas with the sensor current Iss at this time.

The third embodiment apparatus acquires an NOx concentration Cnox in exhaust gas by controlling the sensor voltage Vss to 0.4 V while applying the pump cell 25 with the voltage Vpp that decreases an oxygen concentration in exhaust gas in the internal space 28 to zero (or nearly zero) and applying a sensor current Iss, which is acquired at this time, to a look-up table MapCnox(Iss). According to the table MapCnox(Iss), as the sensor current Iss increases, a higher NOx concentration Cnox is acquired.

Next, acquisition of an oxygen concentration will be described. There is also the relation shown in FIG. 3 between a voltage that is applied from the pump cell voltage source 25C to the pump cell 25 (hereinafter, referred to as pump voltage Vpp) and a pump current Ipp. The third embodiment apparatus acquires an oxygen concentration Coxy in exhaust gas by applying a pump current Ipp to a look-up table MapCoxy(Ipp). The pump current Ipp is acquired when the pump voltage Vpp that decreases an oxygen concentration in exhaust gas in the internal space 28 to zero (or nearly zero) is being applied to the pump cell 25. According to the table MapCoxy(Ipp), as the pump current Ipp increases, a higher oxygen concentration Coxy is acquired.

With this configuration, the third embodiment apparatus is able to acquire an oxygen concentration Coxy in exhaust gas in addition to an SOx concentration Csox and an NOx concentration Cnox in exhaust gas.

The relation among a sensor voltage Vss, a sensor current Iss, and an oxygen concentration Coxy in exhaust gas is also the same relation as the relation shown in FIG. 3. Therefore, the third embodiment apparatus may also be configured to decrease the pump voltage Vpp to zero in a state where the sensor voltage Vss has been controlled to 0.4 V and acquire an oxygen concentration Coxy in exhaust gas by applying the sensor current Iss acquired at that time to the look-up table MapCoxy(Iss). According to the table MapCoxy(Iss), as the sensor current Iss increases, a higher oxygen concentration Coxy is acquired.

Next, a specific operation of the third embodiment apparatus will be described. The CPU of the sensor ECU 93 of the third embodiment apparatus (hereinafter, referred to as the CPU of the third embodiment apparatus), as in the case of the first embodiment apparatus, executes the routine shown in FIG. 9 each time a predetermined time elapses.

However, when the CPU of the third embodiment apparatus executes the routine shown in FIG. 9, the CPU of the third embodiment apparatus acquires a base SOx concentration Csox_base by applying a peak value dIpeak to the look-up table Map2Csox_base(dIpeak) in step 955 of FIG. 9.

The CPU of the third embodiment apparatus executes the processes of step 1665, step 1670, and step 1675 of FIG. 16 instead of the processes of step 965, step 970, and step 975 of FIG. 9.

The CPU of the third embodiment apparatus separately controls the pump cell voltage source 25C such that the pump voltage Vpp that decreases an oxygen concentration in exhaust gas in the internal space 28 to zero (or nearly zero) is applied to the pump cell 25.

When the value of the SOx concentration acquisition request flag X1 is 0 at the time when the CPU of the third embodiment apparatus executes the process of step 905, the CPU of the third embodiment apparatus makes negative determination in step 905, and sequentially executes the processes of step 1665, step 1670, and step 1675, which will be described below. After that, the CPU of the third embodiment apparatus proceeds to step 995, and ends the routine.

In step 1665, the CPU of the third embodiment apparatus executes sensor voltage control for controlling the sensor voltage Vss to 0.4 V.

In step 1670, the CPU of the third embodiment apparatus acquires a pump current Ipp and a sensor current Iss.

In step 1675, the CPU of the third embodiment apparatus acquires an oxygen concentration Coxy in exhaust gas by applying the pump current Ipp acquired in step 1670 to the look-up table MapCoxy(Ipp), and acquires an NOx concentration Cnox in exhaust gas by applying the sensor current Iss acquired in step 1670 to the look-up table MapCnox(Iss).

The CPU of the third embodiment apparatus executes the routine shown in FIG. 10 each time a predetermined time elapses.

The specific operation of the third embodiment apparatus is described above. With this configuration, the third embodiment apparatus is able to acquire an SOx concentration Csox, an NOx concentration Cnox, and an oxygen concentration Coxy. Even when the first sensor electrode 26A degrades, the third embodiment apparatus is able to acquire an accurate SOx concentration Csox as an SOx index.

Next, an SOx index acquisition apparatus for an internal combustion engine according to an alternative embodiment of the third embodiment (hereinafter, referred to as third alternative apparatus) will be described. As described above, the inventors of the present application have found out that a solid electrolyte resistance Rden increases as the degree of degradation of the first sensor electrode 26A increases.

The third alternative apparatus acquires a correction coefficient Kc for correcting a base SOx concentration Csox_base with the solid electrolyte resistance Rden instead of the electrode interface resistance Rkai.

More specifically, the third alternative apparatus acquires the real part of a first impedance Z1 as a solid electrolyte resistance Rden, and acquires a correction coefficient Kc by applying the acquired solid electrolyte resistance Rden to the look-up table MapKc(Rden).

As the degree of degradation of the first sensor electrode 26A increases, the solid electrolyte resistance Rden increases, with the result that the passage sensor current Iss for the same SOx concentration increases while the sensor voltage Vss is decreased from 0.8 V to 0.2 V. For this reason, the peak value dIpeak decreases. Therefore, the table MapKc(Rden) is prepared such that a larger correction coefficient Kc is acquired as the solid electrolyte resistance Rden increases. The correction coefficient Kc is a value larger than or equal to one.

The third alternative apparatus acquires an SOx concentration Csox by correcting a base SOx concentration Csox_base by multiplying an acquired correction coefficient Kc by the base SOx concentration Csox_base (Csox=Csox_base·Kc).

The third alternative apparatus acquires an SOx concentration Csox by correcting a base SOx concentration Csox_base with a solid electrolyte resistance Rden that varies in accordance with the degree of degradation of the first sensor electrode 26A. Therefore, the third alternative apparatus is able to acquire an accurate SOx concentration Csox as an SOx index even when the first sensor electrode 26A degrades.

The third alternative apparatus may be configured not to correct a base SOx concentration Csox_base with a correction coefficient Kc. The third embodiment apparatus may also be configured to acquire a correction coefficient Ki_2 for correcting a peak value dIpeak based on a solid electrolyte resistance Rden, correct the peak value dIpeak by multiplying the correction coefficient Ki_2 by the peak value dIpeak, acquire a base SOx concentration Csox_base by applying the corrected peak value dIpeak to the look-up table Map2Csox_base(dIpeak), and acquire the base SOx concentration Csox_base as an SOx concentration Csox.

In this case, the correction coefficient Ki_2 is a value larger than or equal to one, and is a value that increases as the solid electrolyte resistance Rden increases.

With this configuration as well, the third alternative apparatus is able to acquire an accurate SOx concentration Csox as an SOx index.

The third alternative apparatus may be configured not to correct a base SOx concentration Csox_base with a correction coefficient Kc. The third alternative apparatus may also be configured to correct the look-up table Map2Csox_base(dIpeak) based on a solid electrolyte resistance Rden, and acquire a base SOx concentration Csox_base, acquired by applying a peak value dIpeak to the corrected look-up table Map2Csox_base(dIpeak), as an SOx concentration Csox.

Next, a specific operation of the third alternative apparatus will be described. The CPU of the sensor ECU 93 of the third alternative apparatus (hereinafter, referred to as the CPU of the third alternative apparatus), as in the case of the first embodiment apparatus, executes the routine shown in FIG. 9 each time a predetermined time elapses.

However, when the CPU of the third alternative apparatus executes the routine shown in FIG. 9, the CPU of the third alternative apparatus acquires a base SOx concentration Csox_base by applying a peak value dIpeak to the look-up table Map2Csox_base(dIpeak) in step 955 of FIG. 9.

The CPU of the third alternative apparatus, as in the case of the first alternative apparatus, executes the routine shown in FIG. 11 each time a predetermined time elapses. However, when the CPU of the third alternative apparatus executes the routine shown in FIG. 11, the CPU of the third alternative apparatus acquires a correction coefficient Kc by applying the solid electrolyte resistance Rden acquired in step 1140 to the look-up table MapKc(Rden), and saves the acquired correction coefficient Kc in the RAM in step 1175 of FIG. 11.

The specific operation of the third alternative apparatus is described above. With this configuration, the third alternative apparatus is able to acquire an SOx concentration Csox, an NOx concentration Cnox, and an oxygen concentration Coxy. Therefore, the third alternative apparatus is able to acquire an accurate SOx concentration Csox as an SOx index even when the first sensor electrode 26A degrades.

Next, an SOx index acquisition apparatus for an internal combustion engine according to a fourth embodiment of the disclosure (hereinafter, referred to as fourth embodiment apparatus) will be described. The fourth embodiment apparatus acquires a high SOx concentration determination result with an SOx concentration Csox acquired based on a sensor current Iss of the sensor 20.

Specifically, the fourth embodiment apparatus, as well as the second embodiment apparatus, prescribes and stores an allowable upper limit of an SOx concentration (that is, allowable upper limit concentration) in exhaust gas when the first sensor electrode 26A has not degraded (that is, when the electrode interface resistance Rkai is a predetermined value), as a base upper limit concentration Cbase.

The fourth embodiment apparatus acquires a correction coefficient Kc_si for correcting the base upper limit concentration Cbase in accordance with the degree of degradation of the first sensor electrode 26A, acquires a corrected upper limit concentration Cth by correcting the base upper limit concentration Cbase with the correction coefficient Kc_si, and acquires a high SOx concentration determination result as an SOx index by using the corrected upper limit concentration Cth.

More specifically, As the degree of degradation of the first sensor electrode 26A increases, an SOx concentration Csox acquired by applying a peak value dIpeak to the look-up table Map2Csox_base(dIpeak) decreases. Therefore, in order to acquire an accurate high SOx concentration determination result, it is required to correct the base upper limit concentration Cbase such that the base upper limit concentration Cbase decreases as the degree of degradation of the first sensor electrode 26A increases.

The fourth embodiment apparatus acquires an electrode interface resistance Rkai, and acquires a correction coefficient Kc_si by applying the acquired electrode interface resistance Rkai to the look-up table MapKc_si(Rkai). The table MapKc_si(Rkai) is prepared such that a smaller correction coefficient Kc_si is acquired as the electrode interface resistance Rkai increases. The correction coefficient Kc_si is a value larger than zero and smaller than or equal to one.

The fourth embodiment apparatus acquires a corrected upper limit concentration Cth by correcting the base upper limit concentration Cbase by multiplying the correction coefficient Kc_si by the base upper limit concentration Cbase (Cth=Cbase·Kc_si).

The fourth embodiment apparatus acquires the base SOx concentration Csox_base as an SOx concentration Csox. The base SOx concentration Csox_base is acquired by applying a peak value dIpeak to the look-up table Map2Csox_base(dIpeak). The fourth embodiment apparatus determines whether the SOx concentration Csox is higher than the corrected upper limit concentration Cth. When the SOx concentration Csox is higher than the corrected upper limit concentration Cth, the fourth embodiment apparatus acquires a determination result that the SOx concentration in exhaust gas is higher than the allowable upper limit concentration. On the other hand, when the SOx concentration Csox is lower than or equal to the corrected upper limit concentration Cth, the fourth embodiment apparatus acquires a determination result that the SOx concentration in exhaust gas is lower than or equal to the allowable upper limit concentration.

With this configuration, the fourth embodiment apparatus acquires a corrected upper limit concentration Cth by correcting a base upper limit concentration Cbase with an electrode interface resistance Rkai that varies in accordance with the degree of degradation of the first sensor electrode 26A, and acquires a determination result as to whether an SOx concentration in exhaust gas is higher than the allowable upper limit concentration by using the corrected upper limit concentration Cth. Therefore, even when the first sensor electrode 26A degrades, the fourth embodiment apparatus is able to acquire an accurate determination result as to whether an SOx concentration in exhaust gas is higher than the allowable upper limit concentration, as an SOx index.

The fourth embodiment apparatus may also be configured to acquire a high SOx concentration determination result based on a peak value dIpeak of the sensor 20.

In this case, the fourth embodiment apparatus prescribes and stores a peak value dIpeak of the sensor 20, corresponding to a base upper limit concentration Cbase, as a base upper limit current (in other words, base determination current) Ibase_2.

The fourth embodiment apparatus acquires a correction coefficient Ki_si_2 by applying an electrode interface resistance Rkai to a look-up table MapKi_si_2(Rkai). The table MapKi_si_2(Rkai) is prepared such that a smaller correction coefficient Ki_si_2 is acquired as the electrode interface resistance Rkai increases. The correction coefficient Ki_si_2 is a value larger than zero and smaller than or equal to one.

The fourth embodiment apparatus acquires a corrected upper limit current (in other words, corrected determination current) Ith_2 by correcting a base upper limit current Ibase_2 by multiplying the acquired correction coefficient Ki_si_2 by the base upper limit current Ibase_2(Ith_2=Ibase_2·Ki_si_2).

The fourth embodiment apparatus determines whether the peak value dIpeak of the sensor 20 is larger than the corrected upper limit current Ith_2. When the peak value dIpeak is larger than the corrected upper limit current Ith_2, the fourth embodiment apparatus acquires a determination result that the SOx concentration in exhaust gas is higher than the allowable upper limit concentration. In contrast, when the peak value dIpeak is smaller than or equal to the corrected upper limit current Ith_2, the fourth embodiment apparatus acquires a determination result that the SOx concentration in exhaust gas is lower than or equal to the allowable upper limit concentration.

With this configuration as well, even when the first sensor electrode 26A degrades, the fourth embodiment apparatus is able to acquire an accurate high SOx concentration determination result as an SOx index.

Next, a specific operation of the fourth embodiment apparatus will be described. The CPU of the sensor ECU 93 of the fourth embodiment apparatus (hereinafter, referred to as the CPU of the fourth embodiment apparatus), as in the case of the second embodiment apparatus, executes the routine shown in FIG. 9 each time a predetermined time elapses.

However, when the CPU of the fourth embodiment apparatus executes the routine shown in FIG. 9, the CPU of the fourth embodiment apparatus acquires sensor currents Iss of the sensor 20 and saves the sensor currents Iss in the RAM in step 940 of FIG. 9.

When the CPU of the fourth embodiment apparatus executes the routine shown in FIG. 9, the CPU of the fourth embodiment apparatus acquires a base SOx concentration Csox_base by applying a peak value dIpeak to the look-up table Map2Csox_base(dIpeak) in step 955 of FIG. 9.

The CPU of the fourth embodiment apparatus, as in the case of the first embodiment apparatus, executes the routine shown in FIG. 10 each time a predetermined time elapses.

However, when the CPU of the fourth embodiment apparatus executes the routine shown in FIG. 10, the correction coefficient acquisition request flag X3 is set to 1 when a request to acquire a correction coefficient Kc_si has been issued, and is set to 0 when acquisition of a correction coefficient Kc_si has completed.

The CPU of the fourth embodiment apparatus acquires a correction coefficient Kc_si by applying the electrode interface resistance Rkai acquired in step 1070 to the look-up table MapKc_si(Rkai), and saves the acquired correction coefficient Kc_si in the RAM in step 1075 of FIG. 10.

The CPU of the fourth embodiment apparatus executes the routine shown by the flowchart in FIG. 12 each time a predetermined time elapses.

The specific operation of the fourth embodiment apparatus is described above. With this configuration, even when the first sensor electrode 26A degrades, the fourth embodiment apparatus is able to acquire an accurate high SOx concentration determination result as an SOx index.

Next, an SOx index acquisition apparatus for an internal combustion engine according to an alternative embodiment of the fourth embodiment (hereinafter, referred to as fourth alternative apparatus) will be described. As described above, the inventors of the present application have found out that a solid electrolyte resistance Rden increases as the degree of degradation of the first sensor electrode 26A increases.

The fourth alternative apparatus acquires a correction coefficient Kc_si for correcting a base upper limit concentration Cbase with the solid electrolyte resistance Rden instead of the electrode interface resistance Rkai.

More specifically, the fourth alternative apparatus acquires the real part of a first impedance Z1 as a solid electrolyte resistance Rden, and acquires a correction coefficient Kc_si by applying the acquired solid electrolyte resistance Rden to the look-up table MapKc_si(Rden).

As the degree of degradation of the first sensor electrode 26A of the sensor 20 increases, a base SOx concentration Csox_base that is acquired by applying a peak value dIpeak to the look-up table Map2Csox_base(dIpeak) decreases. Therefore, the look-up table MapKc_si(Rden) for acquiring a correction coefficient Kc_si is prepared such that a smaller correction coefficient Kc_si is acquired as the solid electrolyte resistance Rden increases. The correction coefficient Kc_si is a value larger than zero and smaller than or equal to one.

The fourth alternative apparatus, as well as the fourth embodiment apparatus, acquires a corrected upper limit concentration Cth by correcting a base upper limit concentration Cbase with the acquired correction coefficient Kc_si, and acquires a high SOx concentration determination result as an SOx index by using the corrected upper limit concentration Cth.

The fourth alternative apparatus acquires a corrected upper limit concentration Cth by correcting a base upper limit concentration Cbase with a solid electrolyte resistance Rden that varies in accordance with the degree of degradation of the first sensor electrode 26A, and acquires a high SOx concentration determination result by using the corrected upper limit concentration Cth. With this configuration, even when the first sensor electrode 26A degrades, the fourth alternative apparatus is able to acquire an accurate high SOx concentration determination result as an SOx index.

The fourth alternative apparatus may also be configured to acquire a high SOx concentration determination result by using a peak value dIpeak of the sensor 20.

In this case, the fourth alternative apparatus prescribes and stores a peak value dIpeak of the sensor 20, corresponding to the base upper limit concentration Cbase, as a base upper limit current (in other words, base determination current) Ibase_2.

The fourth alternative apparatus acquires a correction coefficient Ki_si_2 by applying a solid electrolyte resistance Rden to a look-up table MapKi_si_2(Rden). The table MapKi_si_2(Rden) is prepared such that a smaller correction coefficient Ki_si_2 is acquired as the solid electrolyte resistance Rden increases. The correction coefficient Ki_si_2 is a value larger than zero and smaller than or equal to one.

The fourth alternative apparatus acquires a corrected upper limit current (in other words, corrected determination current) Ith_2 by correcting a base upper limit current Ibase_2 by multiplying the acquired correction coefficient Ki_si_2 by the base upper limit current Ibase_2(Ith_2=Ibase_2·Ki_si_2).

The fourth alternative apparatus determines whether the peak value dIpeak of the sensor 20 is larger than the corrected upper limit current Ith_2. When the peak value dIpeak is larger than the corrected upper limit current Ith_2, the fourth alternative apparatus acquires a determination result that the SOx concentration in exhaust gas is higher than the allowable upper limit concentration. In contrast, when the peak value dIpeak is smaller than or equal to the corrected upper limit current Ith_2, the fourth alternative apparatus acquires a determination result that the SOx concentration in exhaust gas is lower than or equal to the allowable upper limit concentration.

With this configuration as well, even when the first sensor electrode 26A degrades, the fourth alternative apparatus is able to acquire an accurate high SOx concentration determination result as an SOx index.

Next, a specific operation of the fourth alternative apparatus will be described. The CPU of the sensor ECU 93 of the fourth alternative apparatus (hereinafter, referred to as the CPU of the fourth alternative apparatus), as in the case of the fourth embodiment apparatus, executes the routine shown in FIG. 9 each time a predetermined time elapses.

However, when the CPU of the fourth alternative apparatus executes the routine shown in FIG. 9, the CPU of the fourth alternative apparatus acquires a base SOx concentration Csox_base by applying a peak value dIpeak to the look-up table Map2Csox_base(dIpeak) in step 955 of FIG. 9.

The CPU of the fourth alternative apparatus, as in the case of the first alternative apparatus, executes the routine shown in FIG. 11 each time a predetermined time elapses.

However, when the CPU of the fourth alternative apparatus executes the routine shown in FIG. 11, the CPU of the fourth alternative apparatus acquires a correction coefficient Kc_si by applying the solid electrolyte resistance Rden acquired in step 1140 to the look-up table MapKc_si(Rden), and saves the acquired correction coefficient Kc_si in the RAM in step 1175.

The CPU of the fourth alternative apparatus, as in the case of the second embodiment apparatus, executes the routine shown in FIG. 12 each time a predetermined time elapses.

The specific operation of the fourth alternative apparatus is described above. With this configuration, even when the first sensor electrode 26A degrades, the fourth alternative apparatus is able to acquire an accurate high SOx concentration determination result as an SOx index.

The disclosure is not limited to the above-described embodiments and alternative embodiments. Various alternative embodiments may be employed within the scope of the disclosure.

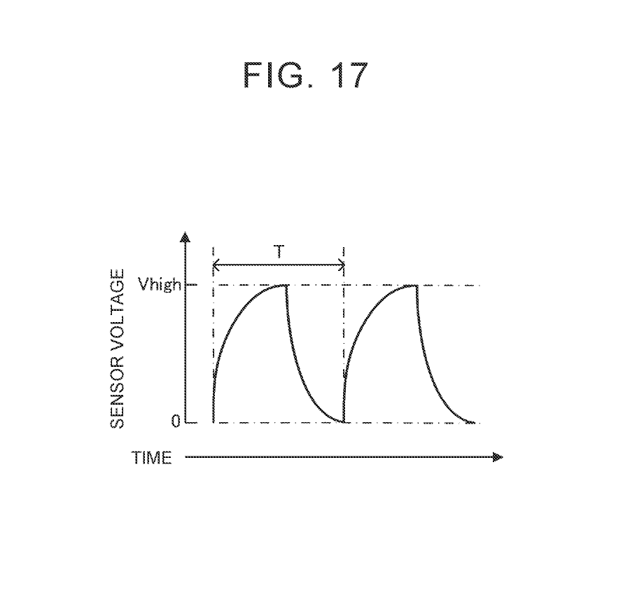

For example, each of the above-described embodiment apparatuses and alternative apparatuses may be configured to repeatedly vary the sensor voltage Vss such that the sensor voltage Vss increases from 0 V to a predetermined voltage Vhigh and then decreases to 0 V as shown in FIG. 17, instead of varying the sensor voltage Vss such that the sensor voltage Vss forms a sine wave with 0 V as its center in the first voltage variation control and the second voltage variation control.

In this case, each of the above-described embodiment apparatuses and alternative apparatuses is configured to vary the variation frequency of the sensor voltage Vss with a period of time T from when the sensor voltage Vss increases from 0 V to the predetermined voltage Vhigh and then decreases to 0 V being set for a time of one period.

When each of the above-described embodiment apparatuses and alternative apparatuses acquires an SOx concentration Csox, each of the above-described embodiment apparatuses and alternative apparatuses increases the sensor voltage Vss before decreasing the sensor voltage Vss. However, as long as the sensor voltage Vss is decreased, it is possible to acquire an SOx concentration Csox even when the sensor voltage Vss is not increased just before the sensor voltage Vss is decreased. Therefore, each of the above-described embodiment apparatuses and alternative apparatuses may also be configured to keep the sensor voltage Vss at 0.8 V until a request to acquire an SOx concentration Csox is issued after acquisition of an SOx concentration Csox has completed, and decrease the sensor voltage Vss from 0.8 V toward 0.2 V when a request to acquire an SOx concentration Csox has been issued.

Each of the above-described embodiment apparatuses and alternative apparatuses acquires a base SOx concentration Csox_base or an SOx concentration Csox with a peak value dIpeak that is a difference between a peak current Ipeak and a reference current Iref. Instead, each of the above-described embodiment apparatuses and alternative apparatuses may also be configured to acquire a base SOx concentration Csox_base or an SOx concentration Csox with a peak current Ipeak itself. In this case, as the peak current Ipeak decreases, a higher base SOx concentration Csox_base or a higher SOx concentration Csox is acquired.

Each of the above-described embodiment apparatuses and alternative apparatuses acquires a high SOx concentration determination result by comparing a corrected upper limit concentration Cth with an SOx concentration Csox acquired based on a peak value dIpeak or comparing a peak value dIpeak with a corrected upper limit current Ith_1 or corrected upper limit current Ith_2.

However, each of the above-described embodiment apparatuses and alternative apparatuses may also be configured to prestore a peak current Ipeak corresponding to a base upper limit concentration Cbase as a base lower limit current (in other words, base determination current), acquire a corrected lower limit current (in other words, corrected determination current) by correcting the base lower limit current based on an electrode interface resistance Rkai or a solid electrolyte resistance Rden, and acquire a high SOx concentration determination result that the SOx concentration is higher than the allowable upper limit concentration when the peak current Ipeak is smaller than the corrected lower limit current.

In this case, the base lower limit current is corrected such that a larger corrected lower limit current is acquired as the electrode interface resistance Rkai or the solid electrolyte resistance Rden increases.

When a catalyst that removes some components in exhaust gas is provided in the exhaust pipe, SOx in exhaust gas can possibly be trapped by the catalyst. In this case, if a sensor is installed in the exhaust pipe downstream of the catalyst, it may not be able to accurately acquire an SOx concentration. When a catalyst is provided in the exhaust pipe, the sensor of each of the above-described embodiment apparatuses and alternative apparatuses is desirably installed in the exhaust pipe upstream of the catalyst.

What is claimed is:

1. An SOx index acquisition apparatus for an internal combustion engine, the SOx index acquisition apparatus comprising:
a sensor cell including a solid electrolyte and a pair of electrodes disposed so as to sandwich the solid electrolyte;
a voltage source configured to apply a voltage to the sensor cell; and
an electronic control unit configured to acquire a resistance of the sensor cell as a sensor resistance, decrease an applied voltage from a predetermined voltage, the applied voltage being a voltage that is applied to the sensor cell, acquire a current that passes through the sensor cell while the applied voltage is being decreased from the predetermined voltage, as an SOx sensor current, acquire a base SOx concentration based on parameters including the SOx sensor current, the base SOx concentration correlating with an SOx concentration in exhaust gas that is emitted from the internal combustion engine, and acquire one of (a) the SOx concentration as an SOx index by correcting the base SOx concentration based on the sensor resistance, or (b) the SOx concentration as an SOx index based on a corrected parameter by acquiring the corrected parameter by correcting at least one of the parameters based on the sensor resistance.

2. The SOx index acquisition apparatus according to claim 1, wherein the sensor resistance is an electrode interface resistance that is a resistance at an interface between the solid electrolyte and one of the electrodes.

3. The SOx index acquisition apparatus according to claim 1, wherein the sensor resistance is a resistance of the solid electrolyte.

4. The SOx index acquisition apparatus according to claim 1, wherein the electronic control unit is configured to acquire a peak value of a current that passes through the sensor cell while the applied voltage is being decreased from the predetermined voltage, as the SOx sensor current.

5. The SOx index acquisition apparatus according to claim 1, wherein the electronic control unit is configured to:
apply a voltage lower than the predetermined voltage before the predetermined voltage is applied to the sensor cell;
increase the applied voltage that is applied to the sensor cell, to the predetermined voltage;
decrease the applied voltage from the predetermined voltage, after increasing the applied voltage to the predetermined voltage; and
acquire a current that passes through the sensor cell while the applied voltage is being decreased from the predetermined voltage, as the SOx sensor current.

6. The SOx index acquisition apparatus according to claim 1, wherein the electronic control unit is configured to:
decrease the applied voltage from the predetermined voltage, and then apply a voltage lower than the predetermined voltage to the sensor cell as an oxygen concentration acquisition voltage;
acquire a current that passes through the sensor cell while the oxygen concentration acquisition voltage is being applied to the sensor cell, as an oxygen sensor current; and
acquire an oxygen concentration in the exhaust gas based on the oxygen sensor current.

7. The SOx index acquisition apparatus according to claim 1, wherein the electronic control unit is configured to:
apply a voltage lower than the predetermined voltage to the sensor cell as an oxygen concentration acquisition voltage before the predetermined voltage is applied to the sensor cell;
acquire a current that passes through the sensor cell while the oxygen concentration acquisition voltage is being applied to the sensor cell, as an oxygen sensor current; and
acquire an oxygen concentration in the exhaust gas based on the oxygen sensor current.

8. An SOx index acquisition apparatus for an internal combustion engine, the SOx index acquisition apparatus comprising:
a sensor cell including a solid electrolyte and a pair of electrodes disposed so as to sandwich the solid electrolyte;
a voltage source configured to apply a voltage to the sensor cell; and
an electronic control unit configured to acquire a resistance of the sensor cell as a sensor resistance, decrease an applied voltage from a predetermined voltage, the applied voltage being a voltage that is applied to the sensor cell, acquire a current that passes through the sensor cell while the applied voltage is being decreased from the predetermined voltage, as an SOx sensor current, acquire a corrected upper limit concentration by correcting a base upper limit concentration based on the sensor resistance, the base upper limit concentration being set based on an allowable upper limit value of an SOx concentration in exhaust gas that is emitted from the internal combustion engine, and acquire one of (c) a determination result that the SOx concentration in the exhaust gas is higher than the allowable upper limit value, as an SOx index, when the SOx concentration is higher than the corrected upper limit concentration, by acquiring the SOx concentration based on parameters including the SOx sensor current and by determining whether the SOx concentration is higher than the corrected upper limit concentration, or (d) a determination result that the SOx concentration in the exhaust gas is higher than the allowable upper limit value based on a comparison result of the SOx sensor current with a corrected determination current, as an SOx index by acquiring the corrected determination current by correcting a base determination current based on the sensor resistance, the base determination current being related to the SOx sensor current corresponding to the base upper limit concentration, and by comparing the SOx sensor current with the corrected determination current.

9. The SOx index acquisition apparatus according to claim 8, wherein the sensor resistance is an electrode interface resistance that is a resistance at an interface between the solid electrolyte and one of the electrodes.

10. The SOx index acquisition apparatus according to claim 8, wherein the sensor resistance is a resistance of the solid electrolyte.

11. The SOx index acquisition apparatus according to claim 8, wherein the electronic control unit is configured to acquire a peak value of a current that passes through the sensor cell while the applied voltage is being decreased from the predetermined voltage, as the SOx sensor current.

12. The SOx index acquisition apparatus according to claim 8, wherein the electronic control unit is configured to:
apply a voltage lower than the predetermined voltage before the predetermined voltage is applied to the sensor cell;
increase the applied voltage that is applied to the sensor cell, to the predetermined voltage;
decrease the applied voltage from the predetermined voltage, after increasing the applied voltage to the predetermined voltage; and
acquire a current that passes through the sensor cell while the applied voltage is being decreased from the predetermined voltage, as the SOx sensor current.

13. The SOx index acquisition apparatus according to claim 8, wherein the electronic control unit is configured to:
decrease the applied voltage from the predetermined voltage, and then apply a voltage lower than the predetermined voltage to the sensor cell as an oxygen concentration acquisition voltage;
acquire a current that passes through the sensor cell while the oxygen concentration acquisition voltage is being applied to the sensor cell, as an oxygen sensor current; and
acquire an oxygen concentration in the exhaust gas based on the oxygen sensor current.

14. The SOx index acquisition apparatus according to claim 8, wherein the electronic control unit is configured to:
apply a voltage lower than the predetermined voltage to the sensor cell as an oxygen concentration acquisition voltage before the predetermined voltage is applied to the sensor cell;
acquire a current that passes through the sensor cell while the oxygen concentration acquisition voltage is being applied to the sensor cell, as an oxygen sensor current; and
acquire an oxygen concentration in the exhaust gas based on the oxygen sensor current.
